(19) United States
(12) Patent Application Publication
(10) Pub. No.: US 2013/0264888 A1
(43) Pub. Date: Oct. 10, 2013

(54) POWER SUPPLYING APPARATUS, POWER RECEIVING APPARATUS, STATE MANAGEMENT METHOD, AND PROGRAM

(71) Applicant: SONY CORPORATION, Tokyo (JP)

(72) Inventors: Yoichiro Sako, Tokyo (JP); Takanori Washiro, Kanagawa (JP); Kazuyoshi Takemura, Tokyo (JP); Taro Tadano, Chiba (JP); Kuniya Hayashi, Tokyo (JP); Kayoko Tanaka, Tokyo (JP); Kazutoshi Serita, Tokyo (JP)

(73) Assignee: SONY CORPORATION, Tokyo (JP)

(21) Appl. No.: 13/803,105

(22) Filed: Mar. 14, 2013

(30) Foreign Application Priority Data
Apr. 4, 2012 (JP) 2012-085361

(51) Int. Cl. H04B 5/00

(52) U.S. Cl. CPC H04B 5/0037
USPC 307/104

(57) ABSTRACT

There is provided a power supplying apparatus including a state determining unit that determines whether power supply with respect to an external apparatus of a power supply object to supply power is enabled, an information generating unit that generates evidence information regarding a power supply disabled state, when the power supply with respect to the external apparatus of the power supply object is disabled, and a transmission control unit that transmits the generated evidence information to at least one external apparatus of a transmission object.

### BACKGROUND

The present disclosure relates to a power supplying apparatus, a power receiving apparatus, a state management method, and a program.

Recently, an apparatus such as a power supplying apparatus for a vehicle, for example, an electric vehicle (EV) that can supply power to an apparatus of a power supply object has appeared. In addition, technology for collecting value corresponding to an amount of power supplied to the apparatus of the power supply object has been developed. An example of the technology for collecting the value corresponding to the amount of power supplied to the apparatus of the power supply object is described in Japanese Patent Application Laid-Open (JP-A) No. 5-126852.

### SUMMARY

An apparatus of a power reception side (hereinafter, referred to as “power receiving apparatus) that receives power receives power transmitted from an apparatus supplying the power (for example, an apparatus of a power transmission side (hereinafter, referred to as “power supplying apparatus”)) by wire (for example, a power line) or wireless. In this case, connection for power transmission between the power supplying apparatus and the power receiving apparatus may be cut due to an intentional reason (for example, an act of stealing power) or an accidental reason (for example, an accident). In addition, power supply from the power supplying apparatus to the power receiving apparatus (external apparatus of a power supply object) may not be performed due to a certain reason such as completion of the power supply.

As such, when the power supply is not performed, at the side of the power receiving apparatus, for example, a user of the power receiving apparatus may not know whether power is received in the power receiving apparatus. In addition, when the power supply is not performed, at the side of the power supplying apparatus, for example, a user of the power supplying apparatus may not know information regarding value for the power supplied to the power receiving apparatus, such as having failed to take value for the power supplied to the power receiving apparatus or having taken the value for the power excessively. That is, when the power supply is not performed, an undesirable situation may occur in both the side of the power receiving apparatus and the side of the power supplying apparatus.

It is desirable to provide a power supplying apparatus, a power receiving apparatus, a state management method, and a program that enable information when power supply is not performed to be securely left.

According to an embodiment of the present disclosure, there is provided a power supplying apparatus including a state determining unit that determines whether power supply with respect to an external apparatus of a power supply object to supply power is enabled, an information generating unit that generates evidence information regarding a power supply disabled state, when the power supply with respect to the external apparatus of the power supply object is disabled, and a transmission control unit that transmits the generated evidence information to at least one external apparatus of a transmission object.

Further, according to an embodiment of the present disclosure, there is provided a power receiving apparatus including a determining unit that determines whether evidence information regarding a state in which power supply in a power supplying apparatus supplying power is disabled is received, and a recording control unit that records the evidence information, when it is determined that the evidence information is received.

Further, according to an embodiment of the present disclosure, there is provided a state management method including determining whether power supply with respect to an external apparatus of a power supply object to supply power is enabled, generating evidence information regarding a power supply disabled state, when the power supply with respect to the external apparatus of the power supply object is disabled, and transmitting the generated evidence information to at least one external apparatus of a transmission object.

Further, according to an embodiment of the present disclosure, there is provided a program for causing a computer to execute determining whether power supply with respect to an external apparatus of a power supply object to supply power is enabled, generating evidence information regarding a power supply disabled state, when the power supply with respect to the external apparatus of the power supply object is disabled, and transmitting the generated evidence information to at least one external apparatus of a transmission object.

According to the embodiments of the present disclosure described above, information when power supply is not performed can be securely left.

### BRIEF DESCRIPTION OF THE DRAWINGS

FIG. 1 is a flowchart illustrating an example of processing according to a state management method in a power supplying apparatus according to an embodiment;

FIG. 2 is a flowchart illustrating an example of processing according to a state management method in a power receiving apparatus according to an embodiment;

FIG. 3 is a diagram illustrating an example of wireless communication according to an embodiment;

FIG. 4 is a diagram illustrating an example of a configuration to realize wireless communication performed between a power supplying apparatus according to an embodiment and a power receiving apparatus according to an embodiment;

FIG. 5 is a diagram illustrating an example of power line communication according to an embodiment;

FIG. 6 is a diagram illustrating an example of a configuration of a power line communication unit included in a power supplying apparatus according to an embodiment;

FIG. 7 is a diagram illustrating another example of a power line communication unit included in a power supplying apparatus according to an embodiment;

FIG. 8 is a diagram illustrating an example of a configuration of a first filter included in a power supplying apparatus according to an embodiment;

FIG. 9 is a diagram illustrating an example of a configuration of a second filter included in a power supplying apparatus according to an embodiment;

FIG. 10 is a diagram illustrating an example of a configuration of a power line communication unit included in a power receiving apparatus according to an embodiment;

FIG. 11 is a diagram illustrating another example of a configuration of a power line communication unit included in a power receiving apparatus according to an embodiment;

FIG. 12 is a diagram illustrating an example of a configuration of a power supplying apparatus according to an embodiment; and

FIG. 13 is a diagram illustrating an example of a configuration of a power receiving apparatus according to an embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

1. State Management Method according to Embodiment
2. Communication according to Embodiment
3. Power Supplying Apparatus and Power Receiving Apparatus according to Embodiment
4. Program according to Embodiment

### (State Management Method According to Embodiment)

Before describing configurations of a power supplying apparatus and a power receiving apparatus according to an embodiment, first, a state management method according to an embodiment will be described. Hereinafter, the state management method according to the embodiment will be described on the basis of the case in which power is transmitted by wire using a power line. The state management method according to the embodiment is not limited to application of the case in which power is transmitted by wire. The state management method according to the embodiment can be applied to the case in which power is transmitted by wireless, such as transmission of power using electromagnetic induction, transmission of power using an electric wave (microwave), transmission of power using resonance of a magnetic field, and transmission of power using resonance of an electric field.

As described above, when power supply is not performed, an undesirable situation may occur in both the side of the power supplying apparatus and the side of the power receiving apparatus. Therefore, the power supplying apparatus and the power receiving apparatus according to the embodiment securely leave information (data) when the power supply is not performed as information (data) showing an evidence in a state in which the power supply is not performed. By securely leaving the information when the power supply is not performed, the undesirable situation can be prevented from occurring.

### [1] State Management Method in Power Supplying Apparatus According to Embodiment

The power supplying apparatus according to the embodiment determines whether power supply with respect to an external apparatus (which corresponds to the power receiving apparatus; hereinafter, also referred to as “power receiving apparatus”) of a power supply object to supply power is enabled (determination processing). When the power supply with respect to the external apparatus of the power supply object is disabled (when it is not determined in the determination processing that the power supply with respect to the external apparatus of the power supply object is enabled), the power supplying apparatus according to the embodiment generates evidence information regarding a state in which the power supply is disabled (information generation processing). Therefore, the power supplying apparatus according to the embodiment transmits the evidence information generated in the information generation processing to the external apparatus of the transmission object (transmission control processing).

In this case, the evidence information according to the embodiment includes information regarding a power supply time. As the information regarding the power supply time according to the embodiment, data showing a time (corresponding to a time when the power supply ends) when it is determined in the determination processing that the power supply with respect to the external apparatus of the power supply object is disabled, data showing a power supply start time and a power supply end time, or data showing a power supply time interval is exemplified.

The evidence information according to the embodiment may include information regarding the value for the supplied power. As the information regarding the value for the supplied power in this embodiment, one or more data of data showing an amount of the supplied power, data showing the value for the amount of the supplied power, data showing a unit price of the power, data showing excess or deficiency of value based on a result of charging processing with respect to the amount of the supplied power, data showing a method of paying a deficit of the value (for example, data demanding a credit payment or data showing a paying destination), and data showing a refund of the value (for example, data showing provided points, history data showing a refund amount, and data demanding a credit refund) are exemplified.

The information that is included in the evidence information according to the embodiment is not limited to the information regarding the power supply time and/or the information regarding the value for the supplied power. For example, in the evidence information according to the embodiment, an ID showing the power supplying apparatus according to the embodiment may be included. In the evidence information according to the embodiment, for example, a recording processing command to record the evidence information on a recording medium may be included.

### (1) Determination Processing

The power supplying apparatus according to the embodiment determines whether the power supply with respect to the external apparatus of the power supply object to supply power is enabled.

### (1-1) First Example of Determination Processing: Determination Processing Based on Power Supply Completion State

The power supplying apparatus according to the embodiment determines whether the power supply to the external apparatus of the power supply object is enabled, on the basis of whether the power supply with respect to the external apparatus of the power supply object is completed.

Specifically, when a signal showing that the power supply with respect to the external apparatus of the power supply object is completed is transmitted from a power control unit to be described below or the external apparatus having the same function as the power control unit, the power supplying apparatus according to the embodiment determines that the power supply with respect to the external apparatus of the power supply object is completed. When it is not determined that the power supply with respect to the external apparatus of the power supply object is completed, the power supplying apparatus according to the embodiment determines that the power supply with respect to the external apparatus of the power supply object is enabled. When it is determined that the power supply with respect to the external apparatus of the power supply object is completed, the power supplying apparatus according to the embodiment does not determine that the power supply with respect to the external apparatus of the power supply object is enabled.

That is, the determination processing according to the first example is determination processing when the power supply is normally completed.

As described above, the state in which the power supply is not performed with respect to the external apparatus of the power supply object may be generated when connection for power transmission between the power supplying apparatus and the power receiving apparatus is cut due to an intentional reason (for example, an act of stealing power) or an accidental reason (for example, an accident) as well as when the power supply is normally completed. Therefore, as another example of the determination processing in the power supplying apparatus according to the embodiment, an example of the determination processing in the cases other than the case in which the power supply is normally completed will be described hereinafter.

(1-2) Second Example of Determination Processing: Determination Processing based on Connection State of Power Line

For example, when the power supplying apparatus according to the embodiment includes a connecting unit (to be described below) to connect a power line through which power is transmitted to the external apparatus, the power supplying apparatus determines whether the power supply with respect to the external apparatus of the power supply object is enabled, on the basis of a connection state of the external apparatus in the connecting unit.

Specifically, the connecting unit (to be described below) detects a change in the connection state of the external apparatus (change from a non-connection state to the connection state or change from the connection state from the non-connection state). The power supplying apparatus according to the embodiment determines whether the power supply with respect to the external apparatus of the power supply object is enabled, on the basis of a detection signal that is transmitted from the detecting unit and shows a detection result. For example, when the detection signal transmitted from the detecting unit before the power supply is completed after the power supply starts shows the change from the connection state to the non-connection state, the power supplying apparatus according to the embodiment does not determine that the power supply with respect to the external apparatus of the power supply object is enabled.

### (1-3) Third Example of Determination Processing: Determination Processing Based on Authentication Result

The power supplying apparatus according to the embodiment authenticates the external apparatus of the power supply object, on the basis of identification information corresponding to the external apparatus of the power supply object. The power supplying apparatus according to the embodiment determines whether the power supply with respect to the external apparatus of the power supply object is enabled, on the basis of an authentication result.

In this case, the identification information according to the embodiment is information that can be used to identify the external apparatus of the power supply object. As the identification information according to the embodiment, data showing a unique identification information of the external apparatus of the power supply object, data showing a type of the external apparatus of the power supply object (for example, data showing a maker or a model number), or power waveform data showing a power waveform when the external apparatus of the power supply object is used (the external apparatus of the power supply object is driven) is exemplified. If the identification information according to the embodiment is information used to identify the external apparatus of the power supply object, the identification information is not limited to the above examples.

Specifically, the power supplying apparatus according to the embodiment performs communication with the external apparatus of the power supply object and acquires the identification information from the external apparatus of the power supply object. The power supplying apparatus according to the embodiment authenticates the external apparatus of the power supply object, on the basis of whether identification information corresponding to the identification information acquired from the external apparatus of the power supply object is stored in a database in which identification information showing external apparatuses where it is allowed to supply power is recorded. In this case, the database may be stored in a recording medium such as a storage unit (to be described below). The power supplying apparatus according to the embodiment may acquire the database from an external apparatus such as a server.

When it is determined that the external apparatus of the power supply object is normally authenticated, the power supplying apparatus according to the embodiment determines that the power supply with respect to the external apparatus of the power supply object is enabled. When it is not determined that the external apparatus of the power supply object is normally authenticated or when the identification information is not acquired from the external apparatus of the power supply object, the power supplying apparatus according to the embodiment does not determine that the power supply with respect to the external apparatus of the power supply object is enabled.

The power supplying apparatus according to the embodiment authenticates the external apparatus of the power supply object before the power supply starts and starts the power supply with respect to the external apparatus, when it is determined that the external apparatus is normally authenticated. After the power supply starts, the power supplying apparatus according to the embodiment transmits an identification information transmission request to request for transmission of the identification information to the external apparatus of the power supply object, regularly or irregularly during a period until the power supply is completed, and acquires the identification information from the external apparatus of the power supply object.

In this case, the power supplying apparatus according to the embodiment acquires the identification information by communication in a communication unit (to be described below), which is included in the power supplying apparatus and performs communication with the external apparatus (power receiving apparatus) of the power supply object, or communication in an external communication apparatus which is connected to the power supplying apparatus and can perform communication with the external apparatus (power receiving apparatus) of the power supply object. An example of communication according to the embodiment between the power supplying apparatus (or the external communication apparatus) and the external apparatus (power receiving apparatus) of the power supply object will be described below.

The method of acquiring the identification information corresponding to the external apparatus of the power supply object by the power supplying apparatus according to the embodiment is not limited to the method of performing communication with the external apparatus of the power supply object and acquiring the identification information. For example, the power supplying apparatus according to the embodiment detects an operation signal based on a user operation (for example, an input operation of an identification number of the external apparatus of the power supply object) transmitted from an operation unit (to be described below) or an operation signal based on a user operation transmitted from an external operation device such as a remote controller, thereby acquiring the identification information corresponding to the external apparatus of the power supply object.

### (1-4) Fourth Example of Determination Processing: Determination Processing Based on Detection Result of External Apparatus of Power Supply Object

For example, when the power supplying apparatus according to the embodiment includes a detecting unit (to be described below) to detect the external apparatus of the power supply object, the power supplying apparatus determines whether the power supply with respect to the external apparatus of the power supply object is enabled, on the basis of a detection result of the external apparatus in the detecting unit,

For example, when the power supplying apparatus according to the embodiment includes a detecting device such as an infrared sensor to detect an object at a position where the external apparatus of the power supply object exists at the time of receiving power as the detecting unit, the power supplying apparatus determines whether the external apparatus of the power supply object exists, on the basis of a detection signal which is transmitted from the detecting device and shows that the object has been detected. For example, when the power supply is performed and the detection signal is detected, the power supplying apparatus according to the embodiment determines that the power supply with respect to the external apparatus of the power supply object is enabled. When the power supply is performed and the detection signal is not detected, the power supplying apparatus according to the embodiment does not determine that the power supply with respect to the external apparatus of the power supply object is enabled.

When the power supplying apparatus according to the embodiment includes an image processing circuit to process an imaging image of the position where the external apparatus of the power supply object exists at the time of supplying power as the detecting unit, the power supplying apparatus determines whether the external apparatus of the power supply object exists, on the basis of a result of image processing with respect to the imaging image in the image processing circuit. For example, when the power supply is performed and the external apparatus of the power supply object is recognized from the imaging image by image processing such as object recognition processing with respect to the imaging image in the image processing circuit, the power supplying apparatus according to the embodiment determines that the power supply with respect to the external apparatus of the power supply object is enabled. When the power supply is performed and the external apparatus of the power supply object is not recognized from the imaging image by the image processing in the image processing circuit, the power supplying apparatus according to the embodiment does not determine that the power supply with respect to the external apparatus of the power supply object is enabled.

When the power supplying apparatus according to the embodiment includes a sensor to detect mass of the object at the position where the external apparatus of the power supply object exists at the time of supplying power as the detecting unit, the power supplying apparatus determines whether the external apparatus of the power supply object exists, on the basis of a detection signal showing the mass to be transmitted from the sensor detecting the mass. For example, when the power supply is performed and the mass shown by the detection signal is equal to or more than a predetermined threshold value (or more than the predetermined threshold value), the power supplying apparatus according to the embodiment determines that the power supply with respect to the external apparatus of the power supply object is enabled. When the power supply is performed and the mass shown by the detection signal is smaller than the predetermined threshold value (or is equal to or smaller than the predetermined threshold value), the power supplying apparatus according to the embodiment does not determine that the power supply with respect to the external apparatus of the power supply object is enabled.

The power supplying apparatus according to the embodiment determines whether the power supply with respect to the external apparatus of the power supply object is enabled, on the basis of the detection result of the external apparatus in the detecting unit, as described above. The detecting unit that is included in the power supplying apparatus according to the embodiment is not limited to the detecting device, the image processing circuit, and the sensor detecting the mass.

The power supplying apparatus according to the embodiment executes one or more processing among the determination processing according to the first to fourth examples as the determination processing. For example, when the plurality of processing among the determination processing according to the first to fourth examples is executed as the determination processing, if it is not determined that the power supply with respect to the external apparatus of the power supply object is enabled in any one of the plurality of processing, the power supplying apparatus according to the embodiment does not determine that the power supply with respect to the external apparatus of the power supply object is enabled. When the plurality of processing is executed as the determination processing, if it is determined that the power supply with respect to the external apparatus of the external apparatus is enabled in each of the plurality of processing, the power supplying apparatus according to the embodiment determines that the power supply with respect to the external apparatus of the power supply object is enabled.

### (2) Information Generation Processing

In the processing of (1) (determination processing), when it is not determined that the power supply with respect to the external apparatus of the power supply object is enabled, that is, when the power supply with respect to the external apparatus of the power supply object is disabled, the power supplying apparatus according to the embodiment generates evidence information.

For example, when the power supplying apparatus according to the embodiment generates evidence information including information regarding a power supply time, the power supplying apparatus specifies the power supply time, on the basis of a measurement result of a timing device composed of a clock or an oscillator, and generates the evidence information including the information regarding the power supply time.

For example, when the power supplying apparatus according to the embodiment generates evidence information including information regarding value for supplied power, the power supplying apparatus generates the information regarding the value for the supplied power, on the basis of a measurement result of an amount of power supplied to the external apparatus of the power supply object, a unit price of the power, or a result of charging processing. In addition, the power supplying apparatus according to the embodiment generates the evidence information including the information regarding the value for the supplied power.

In this case, the power supplying apparatus according to the embodiment performs communication with an external apparatus such as a server (for example, a server of a power company) to manage supplied power, acquires data showing a unit price of the power, and specifies the unit price of the power. The power supplying apparatus according to the embodiment may receive data showing the unit price of the power to be packetized and transmitted by the power line and specify the unit price of the power.

As the charging processing in the power supplying apparatus according to the embodiment, processing for performing charging for the external apparatus by performing communication with the external apparatus is exemplified. Specifically, the power supplying apparatus according to the embodiment transmits a charging processing command to subtract a value corresponding to value from electronic value (money or data having value based on the money) to the external apparatus of the power supply object. As the charging processing command according to the embodiment, data including data showing processing content and data showing a subtracted value of the electronic value is exemplified. The charging processing command according to the embodiment is not limited to the above example. For example, the charging processing command according to the embodiment may be data showing processing for transmitting electronic value of a value corresponding to value shown by charging information to the external apparatus (processing for moving the electronic value).

In this case, after the power supply starts, when it is not determined that the power supply with respect to the external apparatus of the power supply object is enabled (when the power supply with respect to the external apparatus of the power supply object is disabled) in the processing of (1) (determination processing), the power supplying apparatus according to the embodiment executes the charging processing. However, timing when the power supplying apparatus according to the embodiment executes the charging processing is not limited to the above example. For example, the power supplying apparatus according to the embodiment may execute the charging processing for every constant time after the power supply starts or may execute the charging processing whenever power of a constant amount is transmitted to the external apparatus of the power supply object.

The charging processing in the power supplying apparatus according to the embodiment is not limited to the above example. For example, the power supplying apparatus according to the embodiment may perform communication with an external charging processing apparatus that can perform charging for a user of the external apparatus of the power supply object (ex-post charging performed after the power supply) and cause the external charging processing apparatus to perform charging for the user of the external apparatus of the power supply object. In this case, a server corresponding to a credit card possessed by the user of the external apparatus of the power supply object or a server corresponding to an account possessed by the user of the external apparatus of the power supply object is exemplified as the external charging processing apparatus according to the embodiment.

Specifically, the power supplying apparatus according to the embodiment transmits information regarding the value for the supplied power to the external charging processing apparatus and causes the external charging processing apparatus to perform charging for the user of the external apparatus of the power supply object. The power supplying apparatus according to the embodiment may transmit identification information showing an apparatus of a charging object (external apparatus of the power supply object) to the external charging processing apparatus.

That is, the charging processing according to the embodiment may be direct charging processing with respect to the external apparatus of the power supply object or indirect charging processing for causing the external charging processing apparatus to execute substantial charging processing. The charging processing according to the embodiment may be combination processing of the direct charging processing and the indirect charging processing (for example, processing for first executing the direct charging processing and executing the indirect charging processing when the direct charging processing is not normally executed).

The power supplying apparatus according to the embodiment specifies excess or deficiency of the value for the supplied power, on the basis of a result of the charging processing. For example, the power supplying apparatus according to the embodiment generates data showing the specified excess or deficiency of the value.

The power supplying apparatus according to the embodiment generates data showing a method of paying a deficit of the value or data showing a method of refunding the value, on the basis of the method of paying the deficit of the value or the method of refunding the value, which has been set in advance or set on the basis of a user operation.

The power supplying apparatus according to the embodiment generates a variety of information included in the evidence information and generates the evidence information including one or more information among the generated information, as described above.

### (3) Transmission Control Processing

The power supplying apparatus according to the embodiment causes the external communication apparatus, which can perform communication with the communication unit or the external apparatuses of the transmission objects connected to the power supplying apparatus, to transmit the evidence information generated in the processing of (2) (information generation processing) to the external apparatus of the transmission object.

In this case, one or more external apparatuses among the external apparatus of the power supply object and the external apparatuses other than the external apparatus of the power supply object are exemplified as the external apparatuses of the transmission objects according to the embodiment. As the external apparatuses other than the external apparatus of the power supply object in this embodiment, one or more external apparatuses among the external apparatuses associated with the external apparatus of the power supply object and the external apparatuses not associated with the external apparatus of the power supply object are exemplified. In this case, a communication apparatus such as a mobile phone or a smart phone and a personal computer (PC) possessed by the user of the external apparatus of the power supply object are exemplified as the external apparatuses associated with the external apparatus of the power supply object in this embodiment. As the external apparatuses not associated with the external apparatus of the power supply object, an external charging processing apparatus and a server to manage the evidence information are exemplified. The external apparatuses associated with the external apparatus of the power supply object in this embodiment and the external apparatuses not associated with the external apparatus of the power supply object in this embodiment are not limited to the above examples.

The power supplying apparatus according to the embodiment specifies the external apparatus of the transmission object, on the basis of transmission destination information showing the external apparatus of the transmission object to transmit the evidence information, which has been set in advance or set (or reset) on the basis of a user operation. The power supplying apparatus according to the embodiment causes the communication unit to transmit the evidence information generated in the processing of (2) (information generation processing) to the specified external apparatus of the transmission object.

In this case, data including information by which the external apparatus of the transmission object can be specified, such as an Internet protocol (IP) address corresponding to the external apparatus of the transmission object or a media access control (MAC) address, is exemplified as the transmission destination information according to the embodiment.

For example, the external apparatus that is matched with the external apparatus shown by the identification information acquired from the external apparatus of the power supply object among the external apparatuses shown by the transmission destination information according to the embodiment corresponds to the external apparatus of the power supply object. The external apparatus that is not matched with the external apparatus shown by the acquired identification information among the external apparatuses shown by the transmission destination information according to the embodiment and is associated with the external apparatus shown by the acquired identification information in the transmission destination information corresponds to the external apparatus associated with the external apparatus of the power supply object. The external apparatus that is not matched with the external apparatus shown by the acquired identification information among the external apparatuses shown by the transmission destination information according to the embodiment and is not associated with the external apparatus shown by the acquired identification information in the transmission destination information corresponds to the external apparatus that is not associated with the external apparatus of the power supply object.

The power supplying apparatus according to the embodiment executes the processing of (1) (determination processing), the processing of (2) (information generation processing), and the processing of (3) (transmission control processing) as the processing according to the state management method according to the embodiment. In this case, the power supplying apparatus according to the embodiment transmits the evidence information, which is generated when the power supply with respect to the external apparatus of the power supply object is disabled on the basis of the result of the processing of (1) (determination processing), to the external apparatus of the transmission object, in the processing of (3) (transmission control processing). Therefore, when it is not determined that the power supply with respect to the external apparatus of the power supply object is enabled in the processing of (1) (determination processing), that is, when the power supply with respect to the external apparatus of the power supply object is disabled, the evidence information regarding the state in which the power supply is disabled can be stored in a recording medium included in the external apparatus of the transmission object.

Therefore, the power supplying apparatus according to the embodiment can securely leave information when the power supply is not performed.

Because the information when the power supply is not performed can be securely left, the evidence information that is acquired from the external apparatus of the transmission object by the power supplying apparatus according to the embodiment is information that accurately shows when the power supply is not performed. Therefore, the power supplying apparatus according to the embodiment acquires the evidence information stored in the recording medium included in the external apparatus of the transmission object from the external apparatus of the transmission object and executes accurate charging processing.

The processing according to the state management method in the power supplying apparatus according to the embodiment is not limited to the processing of (1) (determination processing) to the processing of (3) (transmission control processing). For example, the power supplying apparatus according to the embodiment may record the evidence information generated in the processing of (2) (information generation processing) in the storage unit or a removable external recording medium connected to the power supplying apparatus (recording control processing).

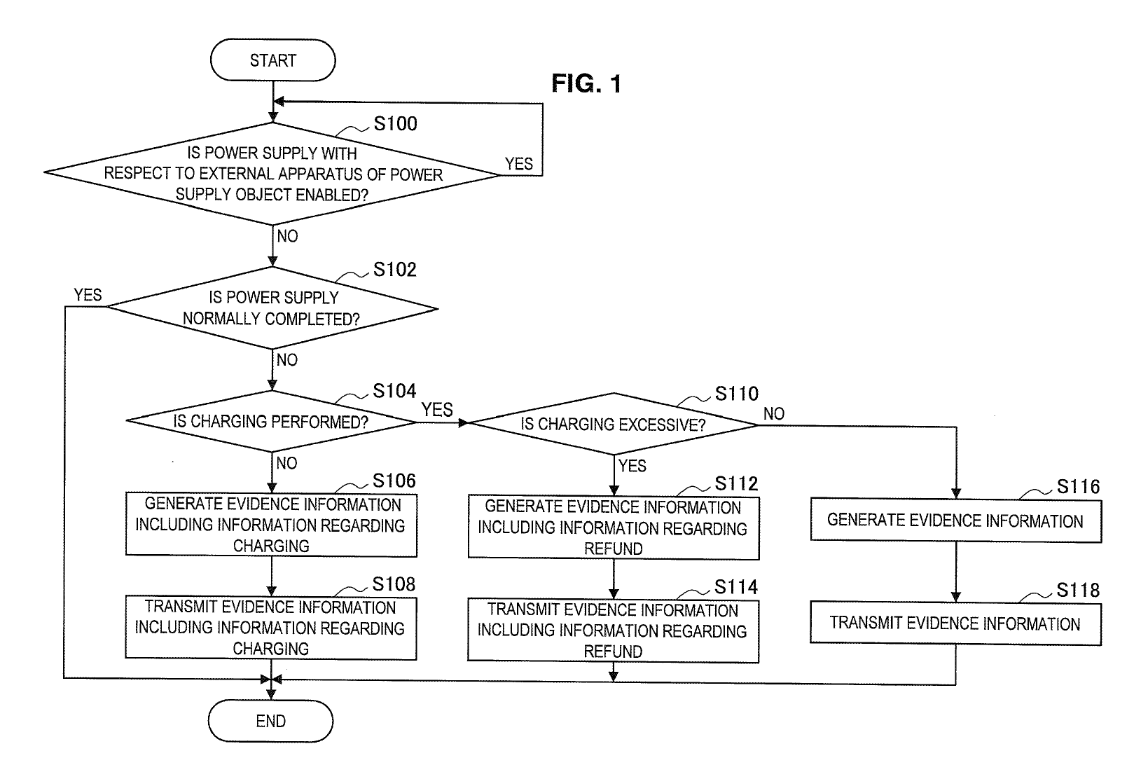

FIG. 1 is a flowchart illustrating an example of the processing according to the state management method in the power supplying apparatus according to the embodiment. In this case, processing of steps S100 and S102 illustrated in FIG. 1 corresponds to the processing of (1) (determination processing) and processing of steps S104, S106, S110, S112, and S116 illustrated in FIG. 1 corresponds to the processing of (2) (information generation processing). In addition, processing of steps S108, S114, and S118 illustrated in FIG. 1 corresponds to the processing of (3) (transmission control processing).

The power supplying apparatus according to the embodiment determines whether the power supply with respect to the external apparatus of the power supply object is enabled (S 100). The power supplying apparatus according to the embodiment executes the processing of step S100 (corresponding to the determination processing according to the second example, the determination processing according to the third example, and the determination processing according to the fourth example), on the basis of the connection state of the external apparatus in the connecting unit, the authentication result based on the identification information, and the detection result of the external apparatus of the power supply object. In this case, when it is determined that the power supply with respect to the external apparatus of the power supply object to supply power is enabled, the power supplying apparatus according to the embodiment determines that the power supply with respect to the external apparatus of the power supply object is enabled. When it is not determined that the power supply with respect to the external apparatus of the power supply object to supply power is enabled, the power supplying apparatus according to the embodiment does not determine that the power supply with respect to the external apparatus of the power supply object is enabled.

When it is determined in step S100 that the power supply with respect to the external apparatus of the power supply object is enabled, the power supplying apparatus according to the embodiment does not advance the processing until it is not determined that the power supply with respect to the external apparatus of the power supply object is enabled.

When it is not determined in step S100 that the power supply with respect to the external apparatus of the power supply object is enabled, the power supplying apparatus according to the embodiment determines whether the power supply is normally completed (S102). The power supplying apparatus according to the embodiment determines that the power supply is normally completed, when information showing that a battery has been fully charged is received from the external apparatus of the power supply object or when power of a predetermined amount or power corresponding to a predetermined amount of money is supplied.

When it is determined in step S102 that the power supply is normally completed, the power supplying apparatus according to the embodiment ends the processing according to the state management method according to the embodiment.

When it is not determined in step S102 that the power supply is normally completed, the power supplying apparatus according to the embodiment determines whether charging for the supplied power is performed (S 104).

When it is not determined in step S104 that the charging for the supplied power is performed, the power supplying apparatus according to the embodiment generates evidence information including information regarding the charging (example of information regarding the value for the supplied power) (S 106). In this case, data showing an amount of money corresponding to the value or data showing value based on the money corresponding to the value is exemplified as the information regarding the charging in this embodiment. In the information regarding the charging in this embodiment, the charging processing command may be included.

If the processing of step S106 is executed, the power supplying apparatus according to the embodiment transmits the generated evidence information to the external apparatus of the transmission object (S108). In this case, the power supplying apparatus according to the embodiment specifies the external apparatus of the transmission object, on the basis of the transmission destination information. The power supplying apparatus according to the embodiment ends the processing according to the state management method according to the embodiment.

When it is determined in step S104 that the charging for the supplied power is performed, the power supplying apparatus according to the embodiment determines whether the charging is excessive (S 110). The power supplying apparatus according to the embodiment compares the value actually charged by the charging processing and the value corresponding to the amount of power actually supplied to the external apparatus of the power supply object and determines that the charging is excessive, when the value actually charged by the charging processing is larger than the value corresponding to the amount of power.

When it is determined in step S110 that the charging is excessive, the power supplying apparatus according to the embodiment generates evidence information including information regarding a refund (example of information regarding the value for the supplied power (S 112). In this case, data regarding the refund of the value such as data showing provided points, history data showing a refund amount, and data demanding a credit refund is exemplified as the information regarding the refund in this embodiment.

If the processing of step S112 is executed, similar to step S108, the power supplying apparatus according to the embodiment transmits the generated evidence information to the external apparatus of the transmission object (S114), similar to step S108 described above. The power supplying apparatus according to the embodiment ends the processing according to the state management method according to the embodiment.

When it is not determined in step S110 that the charging is excessive, the power supplying apparatus according to the embodiment generates the evidence information (S116). In this case, the information regarding the power supply time and/or the information regarding the value for the supplied power is exemplified as the evidence information generated in step S110.

If the processing of step S116 is executed, similar to step S108, the power supplying apparatus according to the embodiment transmits the generated evidence information to the external apparatus of the transmission object (S118). The power supplying apparatus according to the embodiment ends the processing according to the state management method according the embodiment.

The power supplying apparatus according to the embodiment executes the processing illustrated in FIG. 1 as the processing according to the state management method. The processing of (1) (determination processing) to the processing of (3) (transmission control processing) are realized by the processing illustrated in FIG. 1. Therefore, the power supplying apparatus according to the embodiment can securely leave the information when the power supply is not performed, by executing the processing illustrated in FIG. 1.

The processing according to the state management method in the power supplying apparatus according to the embodiment is not limited to the processing illustrated in FIG. 1. For example, when it is determined in step S102 illustrated in FIG. 1 that the power supply is normally completed, the power supplying apparatus according to the embodiment may execute the same processing as steps S116 and S118 illustrated in FIG. 1.

For example, when it is not determined in step S104 illustrated in FIG. 1 that the charging for the supplied power is performed, the power supplying apparatus according to the embodiment may execute at least one of the charging processing according to the embodiment and processing for issuing and sending a bill to the user of the external apparatus of the power supply object, (instead of the processing of steps S106 and S108).

For example, when it is determined in step S110 illustrated in FIG. 1 that the charging is excessive, the power supplying apparatus according to the embodiment may execute at least one of processing for providing points corresponding to a refund amount to the external apparatus of the power supply object (or the user of the external apparatus of the power supply object), credit refund processing with respect to the user of the external apparatus of the power supply object, processing for issuing and sending a payment notice of a refund amount to the user of the external apparatus of the power supply object, and processing for transmitting a refund processing command to add a value corresponding to a refund amount to electronic value to the external apparatus of the power supply object (or processing for transmitting electronic value of a value corresponding to a refund amount to the external apparatus), (instead of the processing of step S112 and S114).

### [2] State Management Method in Power Receiving Apparatus According to Embodiment

Next, a state management method in the power receiving apparatus (corresponding to the external apparatus of the power supply object) according to the embodiment will be described. The power receiving apparatus according to the embodiment determines whether the evidence information transmitted from the power supplying apparatus (power supplying apparatus supplying power) according to the embodiment is received (determination processing). When it is determined that the evidence information is received in the determination processing, the power receiving apparatus according to the embodiment records the evidence information (recording control processing).

### (I) Determination Processing

The power receiving apparatus according to the embodiment determines whether the evidence information (evidence information regarding a state in which the power supply in the power supplying apparatus supplying power is disabled) according to the embodiment is received. The power receiving apparatus according to the embodiment may determine information that is included in the received evidence information.

The power receiving apparatus according to the embodiment refers to a specific portion of received data such as a header portion of the received data and performs the determination. An example of communication between the power supplying apparatus (or the external communication apparatus connected to the power supplying apparatus according to the embodiment) according to the embodiment and the power receiving apparatus (the external apparatus of the power supply object) according to the embodiment will be described below.

### (II) Recording Control Processing

When it is determined that the evidence information is received in the processing of (I) (determination processing), the power receiving apparatus according to the embodiment stores the received evidence information in the recording medium. As the recording medium in which the power receiving apparatus according to the embodiment stores the received evidence information, a storage unit (to be described below) included in the power receiving apparatus according to the embodiment, a removable external recording medium connected to the power receiving apparatus according to the embodiment, or a recording medium included in the external apparatus connected to the power receiving apparatus according to the embodiment through a network (or connected directly to the power receiving apparatus) by wire or wireless is exemplified.

The power receiving apparatus according to the embodiment executes the processing of (I) (determination processing) and the processing of (II) (recording control processing) as the processing according to the state management method according to the embodiment. In this case, the power receiving apparatus according to the embodiment stores the evidence information according to the embodiment determined as being received in the processing of (I) (determination processing) in the recording medium, in the processing of (II) (recording control processing). As described above, the evidence information according to the embodiment is information when the power supply is not performed, which is transmitted from the power supplying apparatus according to the embodiment when the power supply is disabled.

Therefore, the power receiving apparatus according to the embodiment executes the processing of (I) (determination processing) and the processing of (II) (recording control processing) as the processing according to the state management method according to the embodiment and can securely leave the information when the power supply is not performed.

The processing according to the state management method in the power receiving apparatus according to the embodiment is not limited to the processing of (I) (determination processing) and the processing of (II) (recording control processing). For example, when it is determined that the evidence information is received in the processing of (I) (determination processing), the power receiving apparatus according to the embodiment may selectively execute the charging processing on the basis of the evidence information (charging processing).

### (III) Charging Processing

When it is determined that information regarding the value for the supplied power is included in the received evidence information in the processing of (I) (determination processing), the power receiving apparatus according to the embodiment executes the charging processing on the basis of the information regarding the value for the supplied power to be included in the evidence information.

In this case, processing for generating a charging processing command to subtract a value corresponding to the value based on the information regarding the value for the supplied power from the electronic value and subtracting the value from the electronic value stored in the recording medium on the basis of the charging processing command (direct charging processing) is exemplified as the charging processing executed by the power receiving apparatus according to the embodiment. Similar to the charging processing in the power supplying apparatus according to the embodiment, the power receiving apparatus according to the embodiment may perform communication with the external charging processing apparatus and cause the external charging processing apparatus to perform charging for the user of the power receiving apparatus according to the embodiment (indirect charging processing). The charging processing in the power receiving apparatus according to the embodiment may be combination processing of the direct charging processing and the indirect charging processing (for example, processing for first executing the direct charging processing and executing the indirect charging processing when the direct charging processing is not normally executed).

For example, when the information regarding the value for the supplied power to be included in the evidence information includes information regarding the charging, the power receiving apparatus according to the embodiment executes the charging processing on the basis of the information regarding the charging. When the information regarding the value for the supplied power to be included in the evidence information includes data showing an amount of supplied power and data showing a unit price of the power, the power receiving apparatus according to the embodiment calculates the value for the supplied power and executes the charging processing based on the calculated value. The example of the charging processing based on the information regarding the value for the supplied power to be included in the evidence information in the power receiving apparatus according to the embodiment is not limited to the above example.

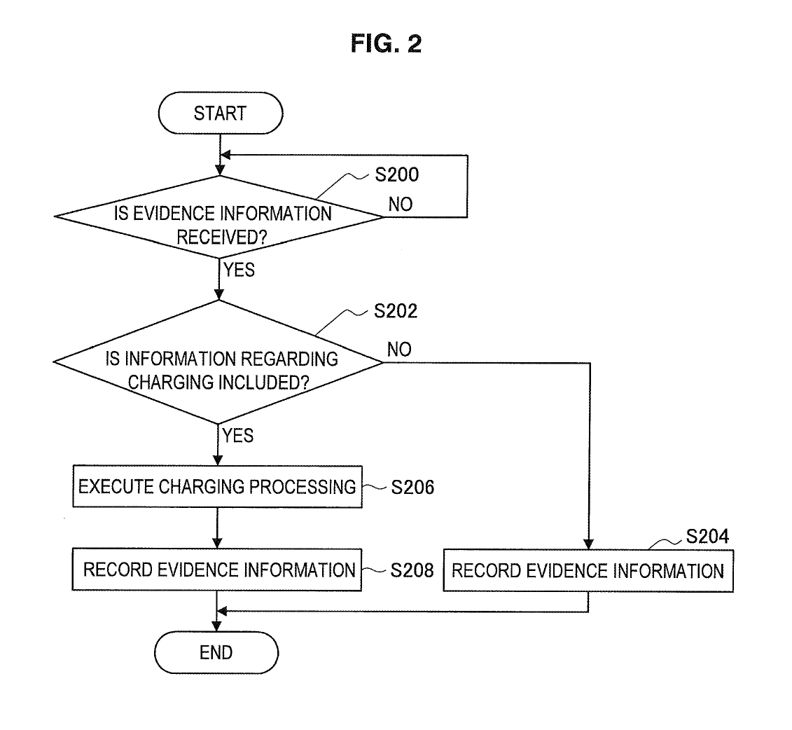

FIG. 2 is a flowchart illustrating an example of the processing according to the state management method in the power receiving apparatus according to the embodiment. In this case, processing of steps S200 and S202 illustrated in FIG. 2 corresponds to the processing of (I) (determination processing) and processing of steps S204 and S208 illustrated in FIG. 2 corresponds to the processing of (II) (recording control processing). In addition, processing of step S206 illustrated in FIG. 2 corresponds to the processing of (III) (charging processing).

The power receiving apparatus according to the embodiment determines whether the evidence information is received (S200). When it is not determined in step S200 that the evidence information is received, the power receiving apparatus according to the embodiment does not advance the processing until it is determined that the evidence information is received.

When it is determined in step S200 that the evidence information is received, the power receiving apparatus according to the embodiment determines whether the information regarding the charging is included in the evidence information (S202).

When it is not determined in step S202 that the information regarding the charging is included in the evidence information, the power receiving apparatus according to the embodiment stores the received evidence information in the recording medium (S204). The power receiving apparatus according to the embodiment ends the processing according to the state management method according to the embodiment.

When it is determined in step S202 that the information regarding the charging is included in the evidence information, the power receiving apparatus according to the embodiment executes the charging processing (S206).

The power receiving apparatus according to the embodiment stores the evidence information in the recording medium (S208). In this case, the evidence information that is stored in the recording medium in step S208 may be the received evidence information or evidence information changed by the power receiving apparatus according to the embodiment according to the result of the processing of step S206 (for example, evidence information to which information showing whether the charging is normally completed is added). The power receiving apparatus according to the embodiment ends the processing according to the state management method according to the embodiment.

The power receiving apparatus according to the embodiment executes the processing illustrated in FIG. 2 as the processing according to the state management method. The processing of (I) (determination processing) to the processing of (III) (charging processing) are realized by the processing illustrated in FIG. 2. Therefore, the power receiving apparatus according to the embodiment can securely leave the information when the power supply is not performed, by executing the processing illustrated in FIG. 2.

The processing according to the state management method in the power receiving apparatus according to the embodiment is not limited to the processing illustrated in FIG. 2. For example, the power receiving apparatus according to the embodiment may not execute the processing of steps S202, S206, and S208 illustrated in FIG. 2. Even when the processing of steps S202, S206, and S208 illustrated in FIG. 2 is not executed, the power receiving apparatus according to the embodiment can realize the processing of (I) (determination processing) and the processing of (II) (recording control processing). Therefore, even when the processing of steps S202, S206, and S208 illustrated in FIG. 2 is not executed, the power receiving apparatus according to the embodiment can securely leave the information when the power supply is not performed.

### (Communication According to Embodiment)

Next, communication performed between the power supplying apparatus (or the external communication apparatus connected to the power supplying apparatus) and the power receiving apparatus (the external apparatus of the power supply object when viewed from the power supplying apparatus), which relates to the processing according to the state management method according to the embodiment, will be described. Hereinafter, the communication according to the embodiment will be described on the basis of an example of the case in which the power supplying apparatus according to the embodiment and the power receiving apparatus according to the embodiment perform communication. Hereinafter, the communication according to the embodiment will be described on the basis of an example of the case in which the power supplying apparatus according to the embodiment and the power receiving apparatus according to the embodiment are connected by a power line, that is, the case in which the power is transmitted by wire using a power line.

As the communication that is performed between the power supplying apparatus according to the embodiment and the power receiving apparatus according to the embodiment, wireless communication and power line communication (wired communication) are exemplified.

Between the power supplying apparatus according to the embodiment and the power receiving apparatus according to the embodiment, the wireless communication is performed using wireless communication technology such as communication technology based on near field communication (NFC) or radio frequency identification (RFID) technology. Between the power supplying apparatus according to the embodiment and the power receiving apparatus according to the embodiment, the power line communication is performed by applying the wireless communication technology such as the communication technology based on the NFC or the RFID technology to the wired communication. In this case, the power line communication according to the embodiment includes communication (so-called contact communication) performed by a contact of a terminal of each apparatus and communication performed by connecting the terminal of each apparatus by wire.

The power supplying apparatus according to the embodiment includes a high-frequency signal generating unit (to be described below) generating a high-frequency signal and transmits the high-frequency signal to the external apparatus. That is, the power supplying apparatus according to the embodiment has a so-called reader/writer function.

The power receiving apparatus according to the embodiment performs load modulation on the basis of a signal transmitted from the external apparatus such as the power supplying apparatus according to the embodiment and performs communication with the external apparatus. For example, when the power receiving apparatus according to the embodiment receives the high-frequency signal transmitted from the power supplying apparatus according to the embodiment, the power receiving apparatus obtains power from the received high-frequency signal, is driven, performs the load modulation on the basis of a processing result of the received high-frequency signal, and transmits the high-frequency signal.

For example, the power supplying apparatus according to the embodiment and the power receiving apparatus according to the embodiment execute the above processing and the wireless communication or the power line communication according to the embodiment is realized between the power supplying apparatus according to the embodiment and the power receiving apparatus according to the embodiment.

In this case, a signal of a frequency used by the RFID or a signal of a frequency used by non-contact communication is exemplified as the high-frequency signal according to the embodiment. For example, 130 to 135 [kHz], 13.56 [MHz], 56 [MHz], 433 [MHz], 954.2 [MHz], 954.8 [MHz], 2441.75 [MHz], and 2448.875 [MHz] are exemplified as frequencies of the high-frequency signal. However, the frequencies of the high-frequency signal according to the embodiment are not limited to the above examples. Hereinafter, a high-frequency wave that is transmitted on the basis of the high-frequency signal according to the embodiment may be called a “carrier”.

The wireless communication according to the embodiment and the power line communication according to the embodiment are not limited to the communication using the wireless communication technology such as the communication technology based on the NFC or the RFID technology. For example, wireless communication of any system such as wireless communication based on IEEE802.11b or power line communication such as power line communication (PLC) (power line carrier communication) may be performed between the power supplying apparatus according to the embodiment and the power receiving apparatus according to the embodiment. Hereinafter, the communication according to the embodiment will be described on the basis of an example of the case in which the communication using the wireless communication technology such as the communication technology based on the NFC or the RFID technology is performed between the power supplying apparatus according to the embodiment and the power receiving apparatus according to the embodiment.

### [1] Wireless Communication According to Embodiment

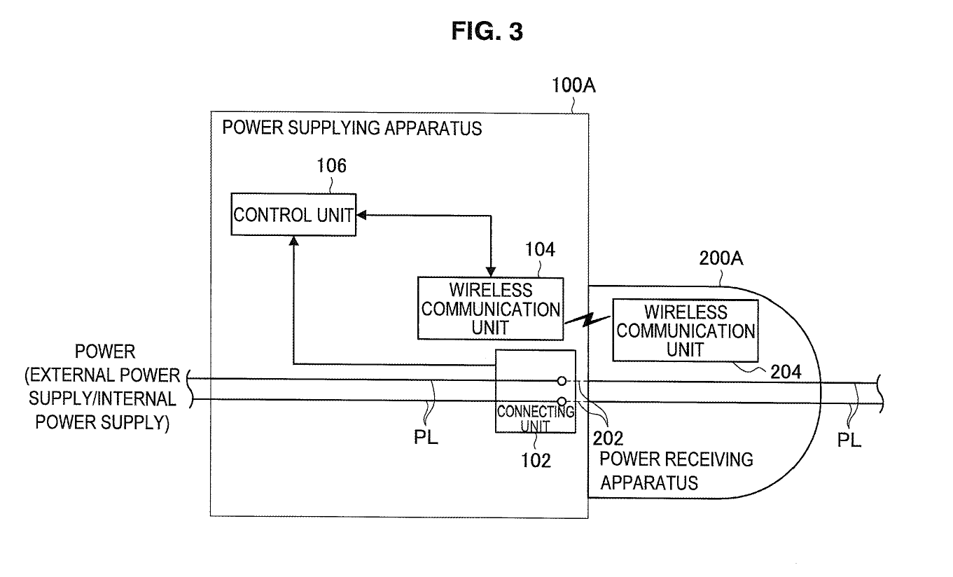

First, the wireless communication according to the embodiment will be described. FIG. 3 is a diagram illustrating an example of the wireless communication according to the embodiment. Hereinafter, the wireless communication according to the embodiment will be described using a power supplying apparatus 100A and a power receiving apparatus 200A illustrated in FIG. 3. FIG. 3 illustrates structural elements relating to the wireless communication according to the embodiment, of a configuration of the power supplying apparatus according to the embodiment and a configuration of a power receiving apparatus according to the embodiment. In FIG. 3, a plug is illustrated as the power receiving apparatus 200A. However, the power receiving apparatus according to the embodiment is not limited to the plug.

The power supplying apparatus 100A includes a connecting unit 102, a wireless communication unit 104, and a control unit 106. The power receiving apparatus 200A includes a connecting unit 202 and a wireless communication unit 204.

The connecting unit 102 connects a power line PL, through which power is transmitted, to the external apparatus. The connecting unit 102 may include a connection supporting member to support maintenance of a connection state of the connected external apparatus. In this case, a power line through which an alternating current of a predetermined frequency such as 50 [Hz] or 60 [Hz] or a direct current flows is exemplified as the power line PL according to the embodiment. As the connection supporting member according to the embodiment, a magnet is exemplified. Hereinafter, an example of the case in which the alternating current of the predetermined frequency flows through the power line PL will be described.

Specifically, the connecting unit 102 has a terminal connected to the power line PL and the connecting unit 202 has a terminal connected to the power line PL (corresponding to an external power line, when viewed from the power supplying apparatus 100A). The terminal of the connecting unit 102 and the terminal of the connecting unit 202 are electrically connected and the power supplying apparatus 100A and the power receiving apparatus 200A (corresponding to the external apparatus, when viewed from the power supplying apparatus 100A) are connected. In this case, the “electrical connection of the terminal of the connecting unit 102 and the terminal of the connecting unit 202 in this embodiment” means that the terminals of the connecting units of the individual apparatuses contact or are connected by wire. Similar to the connecting unit 102 included in the power supplying apparatus 100A, the connecting unit 202 may include a connection supporting member to support maintenance of a connection state of the connected external apparatus.

The connecting unit 102 detects a change in the connection state of the external apparatus (a change from a non-connection state to the connection state/change from the connection state to the non-connection state). The connecting unit 102 transmits a detection signal showing a detection result to the control unit 106. When the wireless communication unit 104 has a function of transmitting a high-frequency signal according to the transmission of the detection signal, the connecting unit 102 may transmit the detection signal to the wireless communication unit 104. The connecting unit 102 may transmit the detection signal to a power supplying unit (to be described below) included in the power supplying apparatus according to the embodiment.

In this case, the connecting unit 102 includes a switch that detects a physical connection state of the external apparatus. When a state of the switch changes, the connecting unit 102 transmits the detection signal to the control unit 106. However, the configuration of the connecting unit 102 is not limited to the above configuration. For example, the connecting unit 102 according to the embodiment may include one or more sensors such as a pressure sensor and an acceleration sensor and transmit a detection signal based on a detection result of the sensor to the control unit 106. When the connecting unit 102 includes the pressure sensor, a detection signal when a pressure equal to or more than a predetermined threshold value (or more than the predetermined threshold value) is detected shows a connection state in which the external apparatus is connected and a detection signal when the pressure equal to or more than the predetermined threshold value (or more than the predetermined threshold value) is not detected shows a non-connection state in which the external apparatus is not connected. When the connecting unit 102 includes the acceleration sensor, each of a connection state and a non-connection state is shown by a direction of acceleration shown by a detection signal when acceleration equal to or more than a predetermined threshold value (or more than the predetermined threshold value) is detected.

When the power supplying apparatus 100A is configured to transmit a high-frequency signal regularly/irregularly or the power supplying apparatus 100A is configured not to execute the determination processing according to the second example (determination processing based on the connection state of the power line), the connecting unit 102 according to the embodiment may be configured not to have a function relating to detection of the change of the connection state of the external apparatus.

The wireless communication units 104 and 204 perform the wireless communication according to the embodiment. The communication in the wireless communication unit 104 is controlled by the control unit 106.

The control unit 106 is configured using a micro processing unit (MPU) or an integrated circuit in which various processing circuits are integrated and controls individual units of the power supplying apparatus 100A. Specifically, the control unit 106 transmits a high-frequency signal generation command or a high-frequency signal transmission stop command to the wireless communication unit 104, on the basis of a detection signal transmitted from the connecting unit 102 or a response signal from the external apparatus such as the power receiving apparatus 200A to be transmitted from the wireless communication unit 104, and controls communication in the wireless communication unit 104.

The control unit 106 takes the initiative in executing the processing (for example, the processing of (1) (determination processing) to the processing of (3) (transmission control processing) according to the state management method according to the embodiment. An example of a configuration to realize the processing according to the state management method according to the embodiment in the control unit 106 included in the power supplying apparatus according to the embodiment will be described below.

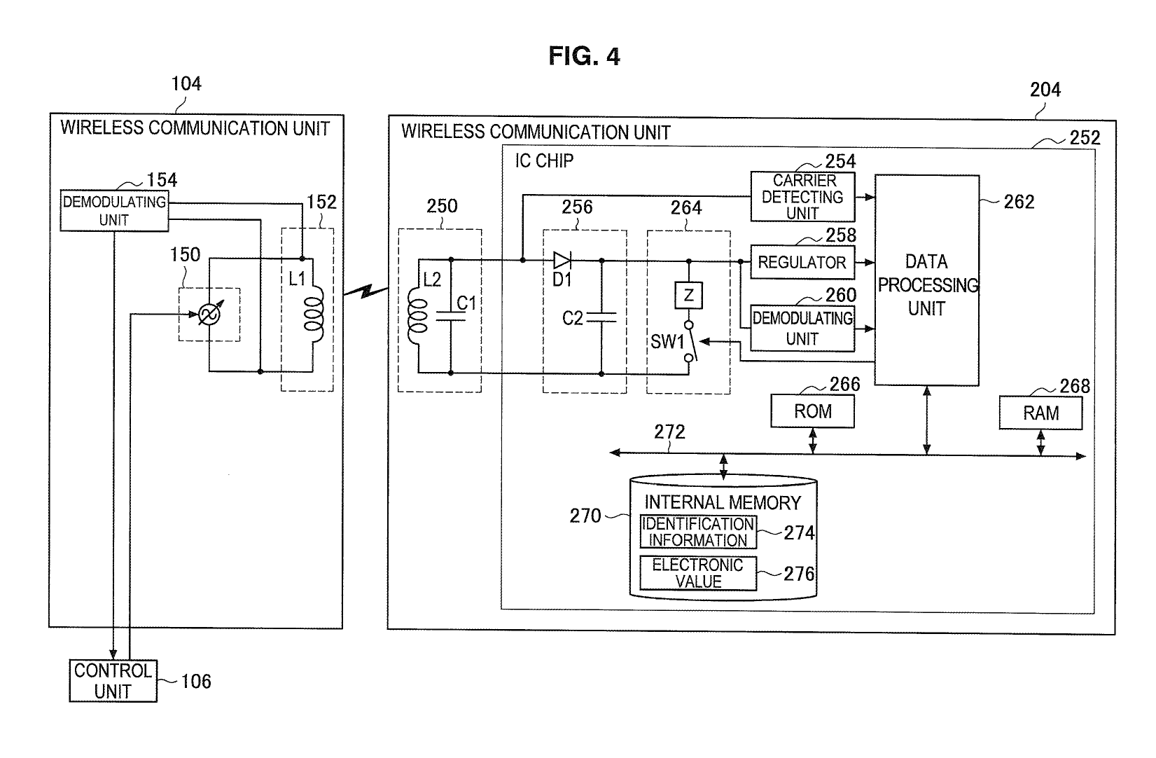

FIG. 4 is a diagram illustrating an example of a configuration to realize the wireless communication performed between the power supplying apparatus according to the embodiment and the power receiving apparatus according to the embodiment. FIG. 4 illustrates an example of configurations of the wireless communication unit 104 and the control unit 106 included in the power supplying apparatus 100A illustrated in FIG. 3 and the wireless communication unit 204 included in the power receiving apparatus 200A illustrated in FIG. 3.

### [1-1] Wireless Communication Unit 104 of Power Supplying Apparatus According to Embodiment

The wireless communication unit 104 includes a high-frequency signal generating unit 150, a high-frequency wave transmitting unit 152, and a demodulating unit 154. The wireless communication unit 104 transmits a high-frequency signal according to the high-frequency signal generation command transmitted from the control unit 106 and stops transmission of the high-frequency signal according to the high-frequency signal transmission stop command transmitted from the control unit 106.

The wireless communication unit 104 may include an encryption circuit (not illustrated in the drawings) to encrypt communication, a communication collision prevention (anti-collision) circuit, and a connection interface (not illustrated in the drawings) for connection with the external apparatus or other circuits. In this case, the wireless communication unit 104 connects the individual structural elements by a bus functioning as a transmission path of data. As the connection interface, a universal asynchronous receiver transmitter (UART), a LAN terminal, and a transmission/reception circuit are exemplified.

The high-frequency signal generating unit 150 receives the high-frequency signal generation command from the control unit 106 and generates a high-frequency signal according to the high-frequency signal generation command. In FIG. 4, an alternating-current power supply is illustrated as the high-frequency signal generating unit 150. However, the high-frequency signal generating unit 150 according to the embodiment is not limited to the above example. For example, the high-frequency signal generating unit 150 according to the embodiment can be configured using a modulation circuit (not illustrated in the drawings) to perform amplitude shift keying (ASK) modulation and an amplification circuit (not illustrated in the drawings) to amplify an output of the modulation circuit.

In this case, a high-frequency signal including an identification information transmission request to request the external apparatus to transmit identification information or a high-frequency signal including various processing commands with respect to the external apparatus or processing data is exemplified as the high-frequency signal generated by the high-frequency signal generating unit 150. The high-frequency signal that is generated by the high-frequency signal generating unit 150 is not limited to the above example. For example, the high-frequency signal according to the embodiment may be a signal (non-modulation signal) to execute a function of supplying power to the power line communication unit 208 of the power receiving apparatus 200A to be described below.

The high-frequency wave transmitting unit 152 includes a coil (inductor; this is applicable to the following description) L1 having predetermined inductance and transmits a carrier according to the high-frequency signal generated by the high-frequency signal generating unit 150. The high-frequency wave transmitting unit 152 can receive a response signal from the external apparatus. That is, the high-frequency wave transmitting unit 152 can execute a function as a communication antenna of the wireless communication unit 104. In FIG. 4, an example of the case in which the high-frequency wave transmitting unit 152 is configured using the coil L1 is illustrated. However, the configuration of the high-frequency wave transmitting unit 152 according to the embodiment is not limited to the above example. For example, the high-frequency wave transmitting unit according to the embodiment may include a capacitor and form a resonance circuit.

The demodulating unit 154 performs envelope detection of an amplitude change of a voltage at an antenna end of the high-frequency wave transmitting unit 152, binarizes a detected signal, and demodulates a response signal from the external apparatus. A demodulation mechanism of the response signal in the demodulating unit 154 is not limited to the above example. For example, the demodulating unit 154 can demodulate the response signal using a phase change of the voltage at the antenna end of the high-frequency wave transmitting unit 152.

The demodulating unit 154 transmits the demodulated response signal to the control unit 106. The control unit 106 to which the demodulated response signal has been transmitted executes various processing such as processing data corresponding to the response signal and generating a high-frequency signal generation command on the basis of a processing result.

By the configuration illustrated in FIG. 4, the wireless communication unit 104 transmits the carrier and demodulates the response signal transmitted from the external apparatus such as the power receiving apparatus 200A. However, the configuration of the wireless communication unit 104 according to the embodiment is not limited to the configuration illustrated in FIG. 4.

### [1-2] Wireless Communication Unit 204 of Power Receiving Apparatus According to Embodiment

The wireless communication unit 204 includes a communication antenna 250 and an IC chip 252. The wireless communication unit 204 connects the individual structural elements by a bus 272 functioning as a transmission path of data.

The communication antenna 250 receives the carrier transmitted from the external apparatus such as the power supplying apparatus 100A and transmits a response signal based on a processing result of processing in the IC chip 252.

The communication antenna 250 is configured using a resonance circuit that includes a coil (inductor) L2 having predetermined inductance and a capacitor C1 having predetermined capacitance and generates an inductive voltage by electromagnetic induction according to reception of the carrier. The communication antenna 250 outputs a reception voltage that is obtained by resonating the inductive voltage with a predetermined resonance frequency. In this case, the resonance frequency in the communication antenna 250 is set according to a frequency of the carrier such as 13.56 [MHz]. By the above configuration, the communication antenna 250 receives the carrier and transmits a response signal by load modulation performed in a load modulating unit 264 (to be described below) included in the IC chip 252.

The IC chip 252 demodulates a high-frequency signal on the basis of the received carrier, processes the high-frequency signal, and transmits a response signal from the communication antenna 250 by the load modulation. That is, the IC chip 252 executes a function as the substantial wireless communication unit of taking the initiative in performing the wireless communication, in the wireless communication unit 204.

The IC chip 252 includes a carrier detecting unit 254, a detecting unit 256, a regulator 258, a demodulating unit 260, a data processing unit 262, a load modulating unit 264, a read only memory (ROM) 266, a random access memory (RAM) 268, and an internal memory 270. The data processing unit 262, the ROM 266, the RAM 268, and the internal memory 270 are connected by the bus 272 functioning as a transmission path of data. Although not illustrated in FIG. 4, the IC chip 252 may further include a protection circuit (not illustrated in the drawings) to prevent an overvoltage or an overcurrent from being applied to the data processing unit 262. In this case, a clamp circuit composed of a diode is exemplified as the protection circuit (not illustrated in the drawings).

The carrier detecting unit 254 generates a rectangular detection signal on the basis of a reception voltage transmitted from the communication antenna 250 and transmits the detection signal to the data processing unit 262. The data processing unit 262 uses the transmitted detection signal as a processing clock for data processing. In this case, because the detection signal is based on the reception voltage transmitted from the communication antenna 250, the detection signal is synchronized with the frequency of the carrier transmitted from the external apparatus. Therefore, the IC chip 252 includes the carrier detecting unit 254 and can execute processing with the external apparatus in synchronization with the external apparatus.

The detecting unit 256 rectifies the reception voltage that is output from the communication antenna 250. In this case, the detecting unit 256 is configured using a diode D1 and a capacitor C2.

The regulator 258 smoothes the reception voltage, converts the reception voltage into a constant voltage, and outputs a driving voltage to the data processing unit 262. In this case, the regulator 258 uses a direct-current component of the reception voltage as the driving voltage.

The demodulating unit 260 demodulates the high-frequency signal on the basis of the reception voltage and outputs data (for example, binarized data signal of a high level and a low level) corresponding to the high-frequency signal included in the carrier. In this case, the demodulating unit 260 outputs an alternating-current component of the reception voltage as data.

The data processing unit 262 is driven using the driving voltage output from the regulator 258 as a power supply and processes data demodulated in the demodulating unit 260. In this case, the data processing unit 262 is configured using an MPU or various processing circuits.

The data processing unit 262 selectively generates a control signal to control the load modulation relating to a response to the external apparatus, according to a processing result. The data processing unit 262 selectively outputs the control signal to the load modulating unit 264.

The data processing unit 262 reads and updates data stored in the internal memory 270, on the basis of a command included in the data demodulated in the demodulating unit 260.

The load modulating unit 264 includes a load Z and a switch SW1. The load modulating unit 264 selectively connects (validates) the load Z according to the control signal transmitted from the data processing unit 262 and performs the load modulation. In this case, the load Z is configured using a resistor having a predetermined resistance value. However, the load Z is not limited to the above example. The switch SW1 is configured using a p-channel-type metal oxide semiconductor field effect transistor (MOSFET) or an n-channel-type MOSFET. However, the switch SW1 is not limited to the above example.

The ROM 266 stores data for control such as a program or an operation parameter used by the data processing unit 262. The RAM 268 temporarily stores a program executed by the data processing unit 262, an operation result, and an execution state.

The internal memory 270 is a storage unit included in the IC chip 252 and has tamper resistance. In the internal memory 270, data is read, newly written, and updated by the data processing unit 262. The internal memory 270 stores various data such as identification information, electronic value, and an application. In FIG. 4, the example of the case in which the internal memory 270 stores identification information 274 and electronic value 276 is illustrated. However, the data that is stored in the internal memory 270 is not limited to the above example.

By the configuration illustrated in FIG. 4, the IC chip 252 processes the high-frequency signal received by the communication antenna 250 and transmits the response signal from the communication antenna 250 by the load modulation.

The wireless communication unit 204 includes the communication antenna 250 and the IC chip 252, processes the high-frequency signal transmitted from the external apparatus such as the power supplying apparatus 100A, and transmits the response signal by the load modulation. The configuration of the wireless communication unit 204 according to the embodiment is not limited to the configuration illustrated in FIG. 4. For example, the wireless communication unit 204 may not include the structural elements forming the IC chip 252 illustrated in FIG. 4 in a form of an integrated circuit (IC) chip.

In the power supplying apparatus and the power receiving apparatus according to the embodiment, the wireless communication unit 104 illustrated in FIG. 4 is included in the power supplying apparatus according to the embodiment, the wireless communication unit 204 illustrated in FIG. 4 is included in the power receiving apparatus according to the embodiment, and the wireless communication can be performed using the wireless communication technology such as the communication technology based on the NFC.

In this case, the wireless communication is performed using the wireless communication technology such as the communication technology based on the NFC or the RFID technology, so that the power receiving apparatus according to the embodiment can obtain power from the received high-frequency signal, can be driven, can perform the load modulation, and can transmit the stored information. That is, in a communication system that includes the power supplying apparatus and the power receiving apparatus according to the embodiment, the power receiving apparatus according to the embodiment can perform wireless communication, even though the power receiving apparatus does not include a separate power supply circuit for communication. The power receiving apparatus according to the embodiment can transmit the stored information by performing the load modulation, even though a signal according to a user operation (signal showing an instruction from the user) is not input to the power receiving apparatus.

### [2] Power Line Communication According to Embodiment

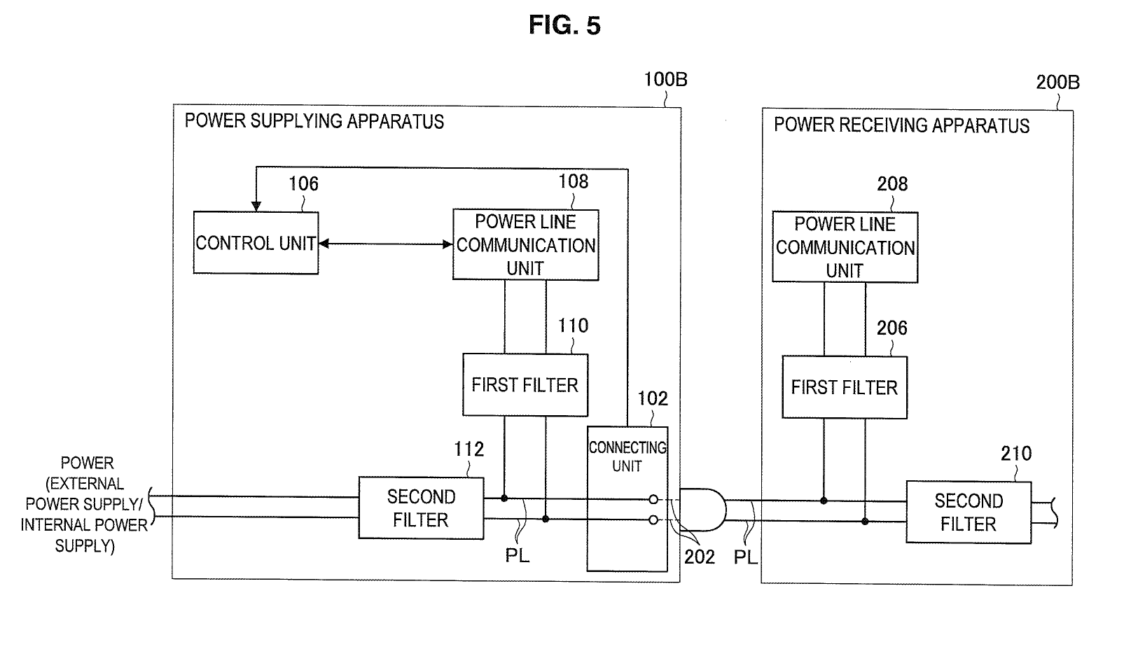

Next, the power line communication according to the embodiment will be described. FIG. 5 is a diagram illustrating an example of the power line communication according to the embodiment. Hereinafter, the power line communication according to the embodiment will be described using a power supplying apparatus 100B and a power receiving apparatus 200B illustrated in FIG. 5. FIG. 5 illustrates structural elements relating to the power line communication according to the embodiment, of a configuration of the power supplying apparatus according to the embodiment and a configuration of the power receiving apparatus according to the embodiment. The structural elements relating to the power line communication in the power receiving apparatus according to the embodiment may be provided in the plug, as in the power receiving apparatus 200A illustrated in FIG. 3.

### [2-1] Power Supplying Apparatus 100B

The power supplying apparatus 100B includes a connecting unit 102, a control unit 106, a power line communication unit 108, a first filter 110 (communication filter), and a second filter 112.

The power supplying apparatus 100B may further include a ROM, a RAM, a storage unit, and a display unit that are not illustrated in the drawings. The power supplying apparatus 100B connects the structural elements by a bus functioning as a transmission path of data. In this case, the ROM (not illustrated in the drawings) stores data for control such as a program or an operation parameter used by the control unit 106. The RAM temporarily stores the program that is executed by the control unit 106.

The storage unit is a storage mechanism included in the power supplying apparatus 100B and stores various data such as identification information acquired from the external apparatus such as the power receiving apparatus 200B, transmission destination information, and an application. In this case, a magnetic recording medium such as a hard disk or a nonvolatile memory such as an electrically erasable and programmable read only memory (EEPROM), a flash memory, a magnetoresistive random access memory (MRAM), a ferroelectric random access memory (FeRAM), and a phase change random access memory (PRAM) is exemplified as the storage unit. The storage unit may be removed from the power supplying apparatus 100B.

The display unit is a display mechanism included in the power supplying apparatus 100B and displays a variety of information (for example, an image and/or a character) on a display screen. As the display screen of the display unit, an operation screen to cause the power supplying apparatus 100B to execute a desired operation is exemplified.

In this case, a display device such as a liquid crystal display or an organic electro-luminescence (EL) display (or organic light emitting diode (OLED) display) is exemplified as the display unit. The power supplying apparatus 100B can form the display unit with a touch screen. In the above case, the display unit functions as an operation display unit in which both a user operation and display are enabled.

The power supplying apparatus 100B can perform communication with an external terminal through a network (or directly) and display the operation screen or the various information on a display screen of the external terminal, regardless of whether the power supplying apparatus 100B includes the display unit. For example, when the external terminal is an external terminal (for example, a portable communication apparatus or a remote controller) possessed by a user of the power supplying apparatus 100B, the user can operate the possessed external terminal and cause the power supplying apparatus 100B to execute desired processing. In addition, the user can confirm information transmitted from the power supplying apparatus 100B, using the external terminal. Therefore, even when it is difficult for the user to directly operate the power supplying apparatus 100B or view information displayed on the display unit, for example, the power supplying apparatus 100B is disposed under a desk, convenience of the user can be improved.

The control unit 106 is configured using an MPU or an integrated circuit in which various processing circuits are integrated and controls the individual units of the power supplying apparatus 100B. Specifically, the control unit 106 transmits a high-frequency signal generation command or a high-frequency signal transmission stop command to the power line communication unit 108, on the basis of a detection signal transmitted from the connecting unit 102 or a response signal from the external apparatus such as the power receiving apparatus 200B to be transmitted from the power line communication unit 108, and controls communication in the power line communication unit 108. The control unit 106 transmits the high-frequency signal generation command or the high-frequency signal transmission stop command to the power line communication unit 108, on the basis of the detection signal, so that the control unit 106 can perform communication with the external apparatus connected through the power line in actuality.

The control unit 106 transmits the high-frequency signal generation command or the high-frequency signal transmission stop command to the power line communication unit 108 as described above, so that the power line communication unit 108 can transmit the high-frequency signal on the basis of the detection result in the connecting unit 102. The control unit 106 transmits the high-frequency signal generation command or the high-frequency signal transmission stop command to the power line communication unit 108, on the basis of the response signal, so that the control unit 106 can control communication using the power line between the external apparatus such as the power receiving apparatus 200B and the control unit 106. The control unit 106 may transmit the high-frequency signal generation command to the power line communication unit 108 regularly/irregularly and cause the power line communication unit 108 to transmit the high-frequency signal regularly/irregularly.

The control unit 106 takes the initiative in executing the processing according to the state management method according to the embodiment (for example, the processing of (1) (determination processing) to the processing of (3) (transmission control processing), as described above. An example of a configuration to realize the processing according to the state management method according to the embodiment in the control unit 106 included in the power supplying apparatus according to the embodiment will be described below.

The power line communication unit 108 performs communication with the external apparatus such as the power receiving apparatus 200B through the power line.

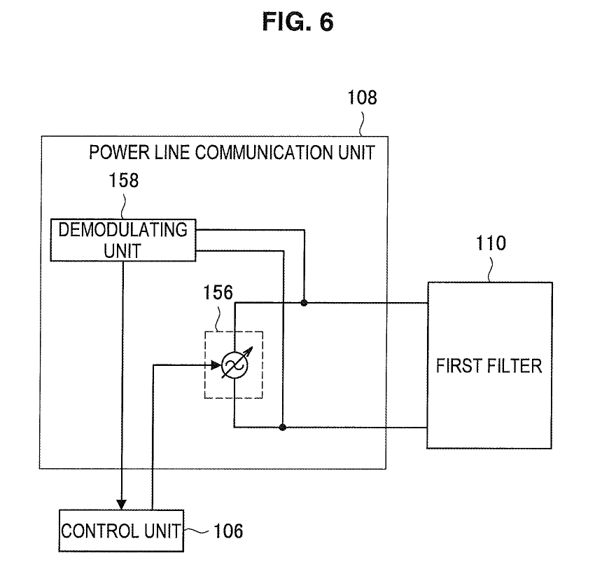

FIG. 6 is a diagram illustrating an example of a configuration of the power line communication unit 108 included in the power supplying apparatus 100B according to the embodiment. In FIG. 6, the power line communication unit 108 is illustrated in conjunction with the control unit 106 and the first filter 110. The power line communication unit 108 includes a high-frequency signal generating unit 156 and a demodulating unit 158 and executes a function as a reader/writer (or an interrogator) in the NFC. The power line communication unit 108 may further include an encryption circuit (not illustrated in the drawings) or a communication collision prevention (anti-collision) circuit.

The high-frequency signal generating unit 156 receives the high-frequency signal generation command transmitted from the control unit 106 and generates a high-frequency signal according to the high-frequency signal generation command. The high-frequency signal generating unit 156 receives the high-frequency signal transmission stop command that is transmitted from the control unit 106 and shows the transmission stop of the high-frequency signal and stops generation of the high-frequency signal. In FIG. 6, an alternating-current power supply is illustrated as the high-frequency signal generating unit 156. However, the high-frequency signal generating unit 156 according to the embodiment is not limited to the above example. For example, the high-frequency signal generating unit 132 according to the embodiment can include a modulation circuit (not illustrated in the drawings) to perform ASK modulation and an amplification circuit (not illustrated in the drawings) to amplify an output of the modulation circuit.

In this case, a high-frequency signal including an identification information transmission request to request the external apparatus to transmit identification information or a high-frequency signal including various processing commands with respect to the external apparatus or processing data is exemplified as the high-frequency signal generated by the high-frequency signal generating unit 156. The high-frequency signal that is generated by the high-frequency signal generating unit 156 is not limited to the above example. For example, the high-frequency signal according to the embodiment may be a signal (non-modulation signal) to execute a function of supplying power to the power line communication unit 208 of the power receiving apparatus 200B to be described below.

The demodulating unit 158 performs envelope detection of an amplitude change of a voltage between the high-frequency signal generating unit 156 and the first filter 110, binarizes a detected signal, and demodulates a response signal transmitted from the external apparatus. The demodulating unit 158 transmits the demodulated response signal (for example, a response signal showing identification information or a response signal showing a response based on the processing according to the high-frequency signal) to the control unit 106. A demodulation mechanism of the response signal in the demodulating unit 158 is not limited to the above example. For example, the demodulating unit 158 can demodulate the response signal using a phase change of the voltage between the high-frequency signal generating unit 156 and the first filter 110.

By the configuration illustrated in FIG. 6, the power line communication unit 108 according to the embodiment executes a function as the reader/writer in the NFC and can perform communication with the external apparatus through the power line.

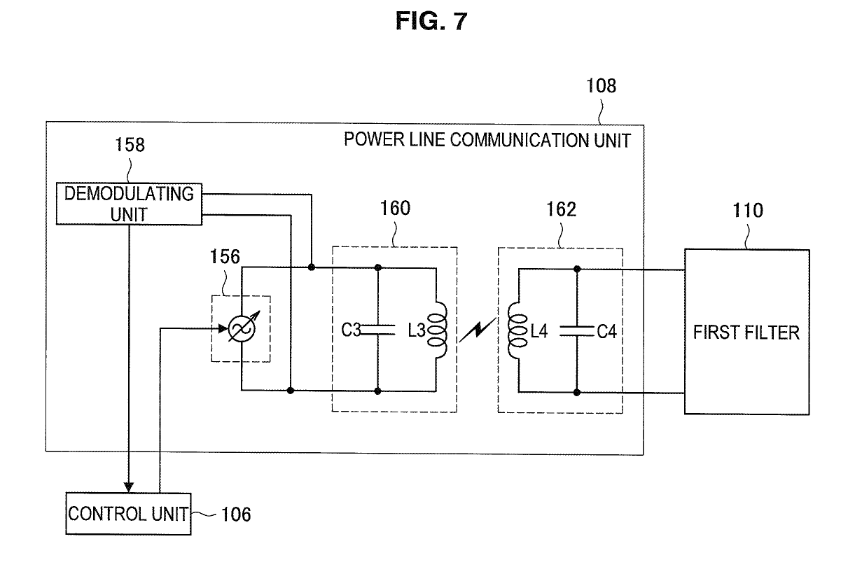

The configuration of the power line communication unit 108 according to the embodiment is not limited to the configuration illustrated in FIG. 6. FIG. 7 is a diagram illustrating another example of the power line communication unit 108 included in the power supplying apparatus 100B according to the embodiment. Similar to FIG. 6, FIG. 7 illustrates the power line communication unit 108 in conjunction with the control unit 106 and the first filter 110.

The power line communication unit 108 according to another example includes a high-frequency signal generating unit 156, a demodulating unit 158, a first high-frequency wave transmitting/receiving unit 160, and a second high-frequency wave transmitting/receiving unit 162. The power line communication unit 108 according to another example may further include an encryption circuit (not illustrated in the drawings) or a communication collision prevention (anti-collision) circuit.

Similar to the high-frequency signal generating unit 156 illustrated in FIG. 6, the high-frequency signal generating unit 156 generates a high-frequency signal according to the high-frequency signal generation command and stops generation of the high-frequency signal according to the high-frequency signal transmission stop command.

The demodulating unit 158 performs envelope detection of an amplitude change of a voltage at an antenna end of the high-frequency signal generating unit 156, binarizes a detected signal, and demodulates a response signal transmitted from the external apparatus. A demodulation mechanism of the response signal in the demodulating unit 158 is not limited to the above example. For example, the demodulating unit 158 can demodulate the response signal using a phase change of the voltage at the antenna end of the high-frequency signal generating unit 156.

The first high-frequency wave transmitting/receiving unit 160 includes a coil (inductor) L3 having predetermined inductance and a capacitor C3 having predetermined capacitance and forms a resonance circuit. In this case, a frequency of a high-frequency signal such as 13.56 [MHz] is exemplified as a resonance frequency of the first high-frequency wave transmitting/receiving unit 156. By the above configuration, the first high-frequency wave transmitting/receiving unit 160 can transmit the high-frequency signal generated by the high-frequency signal generating unit 156 and can receive the response signal transmitted from the external apparatus to be transmitted from the second high-frequency wave transmitting/receiving unit 162. That is, the first high-frequency wave transmitting/receiving unit 160 executes a function as a first communication antenna in the power line communication unit 108.

The second high-frequency wave transmitting/receiving unit 162 includes a coil L4 having predetermined inductance and a capacitor C4 having predetermined capacitance and forms a resonance circuit. In this case, a frequency of a high-frequency signal such as 13.56 [MHz] is exemplified as a resonance frequency of the second high-frequency wave transmitting/receiving unit 162. By the above configuration, the second high-frequency wave transmitting/receiving unit 162 can receive the high-frequency signal transmitted from the first high-frequency wave transmitting/receiving unit 160 and transmit the response signal transmitted from the external apparatus. That is, the second high-frequency wave transmitting/receiving unit 162 executes a function as a second communication antenna in the power line communication unit 108.

Similar to the configuration illustrated in FIG. 6, by the configuration illustrated in FIG. 7, the power line communication unit 108 according to the embodiment can execute a function as the reader/writer in the NFC and can perform communication with the external apparatus through the power line.

Referring to FIG. 5 again, an example of a configuration relating to the power line communication according to the embodiment in the power supplying apparatus 100B according to the embodiment will be described. The first filter 110 is connected between the power line communication unit 108 and the power line PL and filters a signal transmitted from the power line PL. Specifically, the first filter 110 has a function of intercepting at least a signal of a frequency of power supplied to the external apparatus such as the power receiving apparatus 200B through the power line and not intercepting a high-frequency signal, among signals transmitted from the power line PL. The power supplying apparatus 100B includes the first filter 110 and does not transmit a signal of a frequency of power, which may become noise, to the power line communication unit 108. Therefore, precision of communication between the power line communication unit 108 and the external apparatus (in the strict sense, the power line communication unit included in the external apparatus, such as the power line communication unit 208 of the power receiving apparatus 200B to be described below) can be improved.

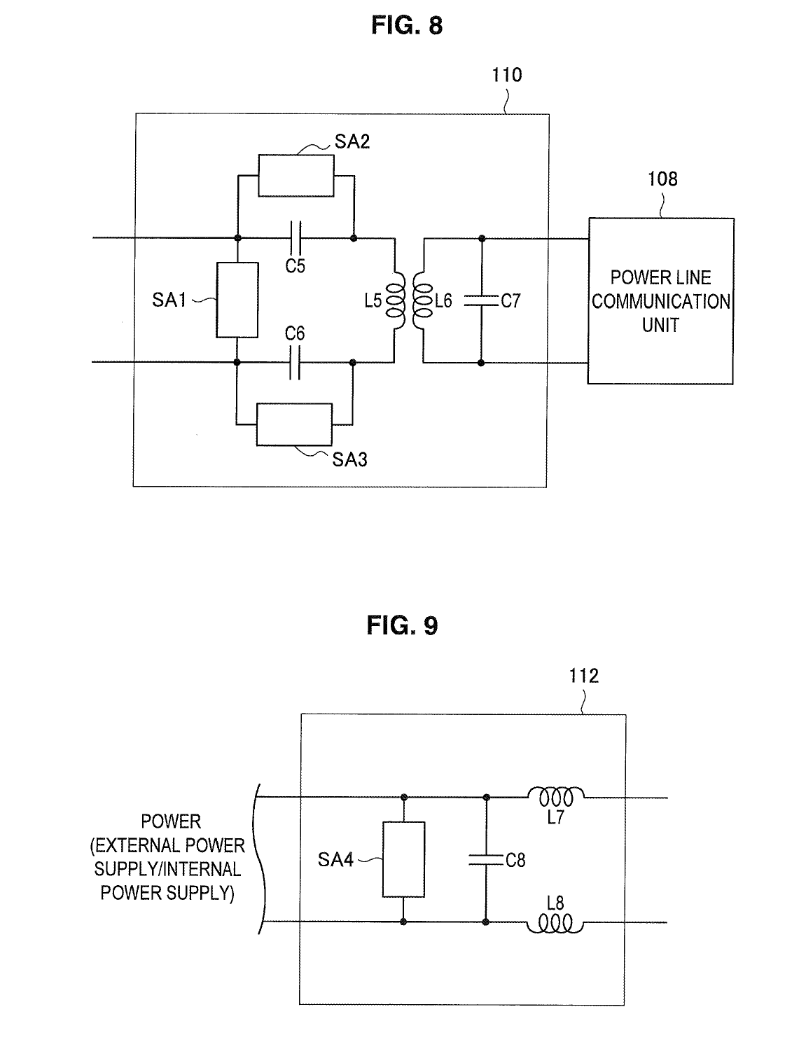

FIG. 8 is a diagram illustrating an example of a configuration of the first filter 110 included in the power supplying apparatus 100B according to the embodiment. The first filter 110 includes coils L5 and L6, capacitors C5 to C7, and surge absorbers SA1 to SA3. However, the configuration of the first filter 110 according to the embodiment is not limited to the configuration illustrated in FIG. 8.

Referring to FIG. 5 again, an example of a configuration relating to the power line communication according to the embodiment in the power supplying apparatus 100B according to the embodiment will be described. The second filter 112 is provided on the power line PL between the connecting unit 102 and the power supply and filters a signal that may be transmitted from the side of the connecting unit 102. In this case, an external power supply such as a commercial power supply or an internal power supply such as a battery is exemplified as the power supply according to the embodiment.

Specifically, the second filter 112 has a function of intercepting at least the high-frequency signal transmitted by the power line communication unit 108 or the high-frequency signal transmitted by the external apparatus and not intercepting a signal of a frequency of power supplied to the external apparatus. The power supplying apparatus 100B includes the second filter 112 and can intercept the high-frequency signal relating to communication through the power line or a noise component transmitted from the side of the external apparatus. That is, the second filter 112 executes a function as a so-called power splitter.

FIG. 9 is a diagram illustrating an example of a configuration of the second filter 112 included in the power supplying apparatus 100B according to the embodiment. The second filter 112 includes coils L7 and L8, a capacitor C8, and a surge absorber SA4. The configuration of the second filter 112 according to the embodiment is not limited to the configuration illustrated in FIG. 9.

By the configuration illustrated in FIG. 5, the power supplying apparatus 100B according to the embodiment can perform communication with the external apparatus such as the power receiving apparatus 200B connected to the connecting unit 102 through the power line. By the configuration illustrated in FIG. 5, the power supplying apparatus 100B according to the embodiment can cause the external apparatus to execute predetermined processing based on the transmitted high-frequency signal, such as transmission of identification information or charging processing using electronic value.

### [2-2] Power Receiving Apparatus 200B

The power receiving apparatus 200B includes a connecting unit 202, a first filter 206, a power line communication unit 208, and a second filter 210.

The power receiving apparatus 200B includes a battery (not illustrated in the drawings) or various devices (for example, an MPU, various processing circuits, and a driving device which are not illustrated in the drawings) to realize a function of the power receiving apparatus 200B, at a rear step of the second filter 210 (the side opposite to the power supplying apparatus 100B in the second filter 210 illustrated in FIG. 5). That is, the power receiving apparatus 200B can charge the battery with power supplied from the external apparatus such as the power supplying apparatus 100B through the power line and can realize the function of the power receiving apparatus 200B using the supplied power. For example, when the power receiving apparatus 200B is a vehicle such as an electric vehicle, the power receiving apparatus 200B receives power, charges the embedded battery with the power, and rotates a wheel using the power of the battery. When the power receiving apparatus 200B includes a display device that can display an image (moving image/still image) and/or a character, the power receiving apparatus 200B receives power and displays the image or the character on a display screen of the display device.

The first filter 206 is connected between the power line (in the strict sense, the power line PL in the power receiving apparatus 200B) and the power line communication unit 208 and filters a signal transmitted from the power line. Specifically, the first filter 206 has a function of intercepting at least a signal of a frequency of power and not intercepting a high-frequency signal, among signals transmitted from the power line. The power receiving apparatus 200B includes the first filter 206 and does not transmit a signal of a frequency of power, which may become noise, to the power line communication unit 208. Therefore, precision of communication between the power line communication unit 208 and the external apparatus (in the strict sense, the power line communication unit included in the external apparatus, such as the power line communication unit 108 of the power supplying apparatus 100B) can be improved.

In this case, the first filter 206 has the same configuration as the first filter 110 of the power supplying apparatus 100B illustrated in FIG. 8. The configuration of the first filter 206 according to the embodiment is not limited to the configuration illustrated in FIG. 8.

By the high-frequency signal, the power line communication unit 208 performs communication with the external apparatus such as the power supplying apparatus 100B through the power line. Specifically, when the power line communication unit 208 receives the high-frequency signal transmitted from the external apparatus, the power line communication unit 208 obtains power from the high-frequency signal, is driven, and executes processing based on the received high-frequency signal. The power line communication unit 208 transmits a response signal according to the processing as the high-frequency signal by the load modulation.

For example, when the power line communication unit 208 receives a high-frequency signal including an identification information transmission request to request for transmission of identification information, the power line communication unit 208 reads the stored identification information, on the basis of the identification information transmission request included in the high-frequency signal. The power line communication unit 208 superposes the read identification information on the power line by the load modulation and transmits the identification information. When the power line communication unit 208 receives a high-frequency signal including various processing commands or processing data, the power line communication unit 208 executes processing based on the processing commands or the processing data included in the high-frequency signal. The power line communication unit 208 superposes a response signal based on the processing on the power line by the load modulation and transmits the response signal. That is, the power line communication unit 208 executes a function as a transponder in the NFC.

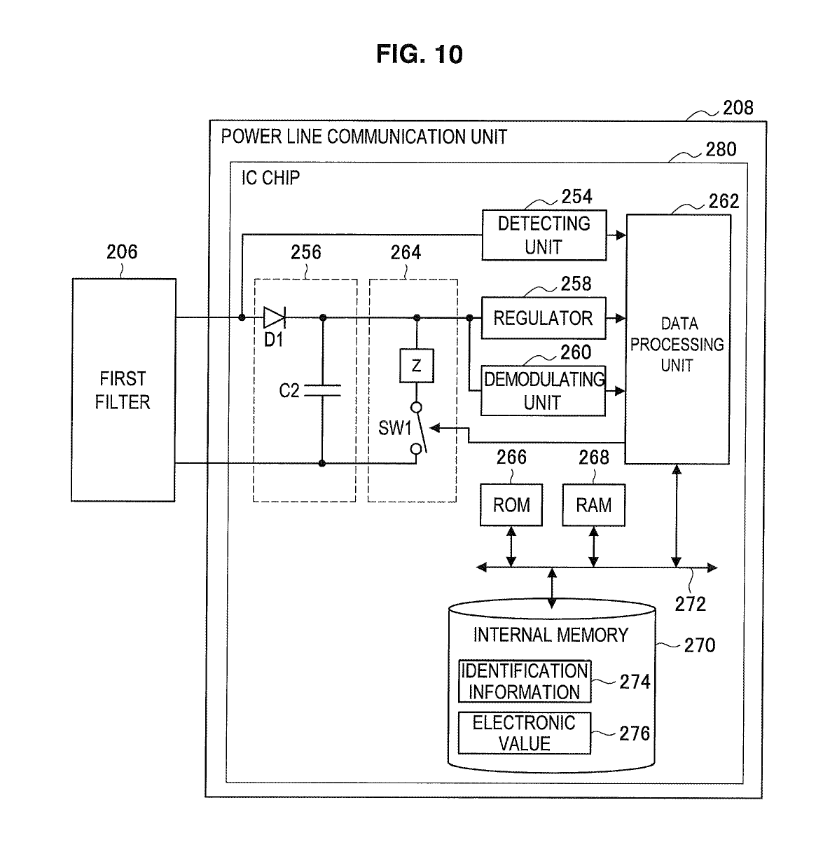

FIG. 10 is a diagram illustrating an example of a configuration of the power line communication unit 208 included in the power receiving apparatus 200B according to the embodiment. In FIG. 10, the power line communication unit 208 is illustrated in conjunction with the first filter 206. In FIG. 10, the power line communication unit 208 includes an IC chip 280 that demodulates the received high-frequency signal, processes the high-frequency signal, and transmits the response signal by the load modulation. The power line communication unit 208 according to the embodiment may not include structural elements forming the IC chip 280 illustrated in FIG. 10 in a form of the IC chip.

The IC chip 280 includes a detecting unit 254, a detecting unit 256, a regulator 258, a demodulating unit 260, a data processing unit 262, and a load modulating unit 264. Although not illustrated in FIG. 10, the IC chip 280 may further include a protection circuit (not illustrated in the drawings) to prevent an overvoltage or an overcurrent from being applied to the data processing unit 262. In this case, a clamp circuit composed of a diode is exemplified as the protection circuit (not illustrated in the drawings).

The IC chip 280 includes a ROM 234, a RAM 236, and an internal memory 238. The data processing unit 262, the ROM 234, the RAM 236, and the internal memory 238 are connected by a bus 240 functioning as a transmission path of data.

In this case, if the configuration of the IC chip 280 illustrated in FIG. 10 and the configuration of the IC chip 252 included in the wireless communication unit 204 of FIG. 4, which relates to the wireless communication according to the embodiment, are compared with each other, the IC chip 280 has the same configuration as the IC chip 252 illustrated in FIG. 4.

As described above, a high-frequency signal based on a carrier received by the communication antenna 250 is input to the IC chip 252 illustrated in FIG. 4 and the IC chip 252 demodulates the high-frequency signal based on the carrier received by the communication antenna 250, processes the high-frequency signal, and transmits the response signal from the communication antenna 250 by the load modulation. Meanwhile, the high-frequency signal transmitted from the external apparatus such as the power supplying apparatus 100B to be transmitted from the first filter 206 is input to the IC chip 280. As illustrated in FIG. 10, the IC chip 280 has the same configuration as the IC chip 252 illustrated in FIG. 4. Therefore, similar to the IC chip 252 illustrated in FIG. 4, the IC chip 280 can demodulate the input high-frequency signal, process the high-frequency signal, and transmit the response signal according to the high-frequency signal by the load modulation.

The IC chip 280 is connected to the first filter 206 as illustrated in FIG. 10 and the first filter 206 is connected to the power line PL as illustrated in FIG. 5. Therefore, the response signal that is transmitted from the IC chip 280 is superposed on the power line through the first filter 206.

By the configuration illustrated in FIG. 10, the IC chip 280 processes the received high-frequency signal, superposes the response signal on the power line by the load modulation, and transmits the response signal. The configuration of the IC chip 280 according to the embodiment is not limited to the configuration illustrated in FIG. 10.

By the configuration illustrated in FIG. 10, the power line communication unit 208 obtains power from the received high-frequency signal, is driven, and executes processing shown by the received high-frequency signal, and can transmit the response signal according to the processing by the load modulation.

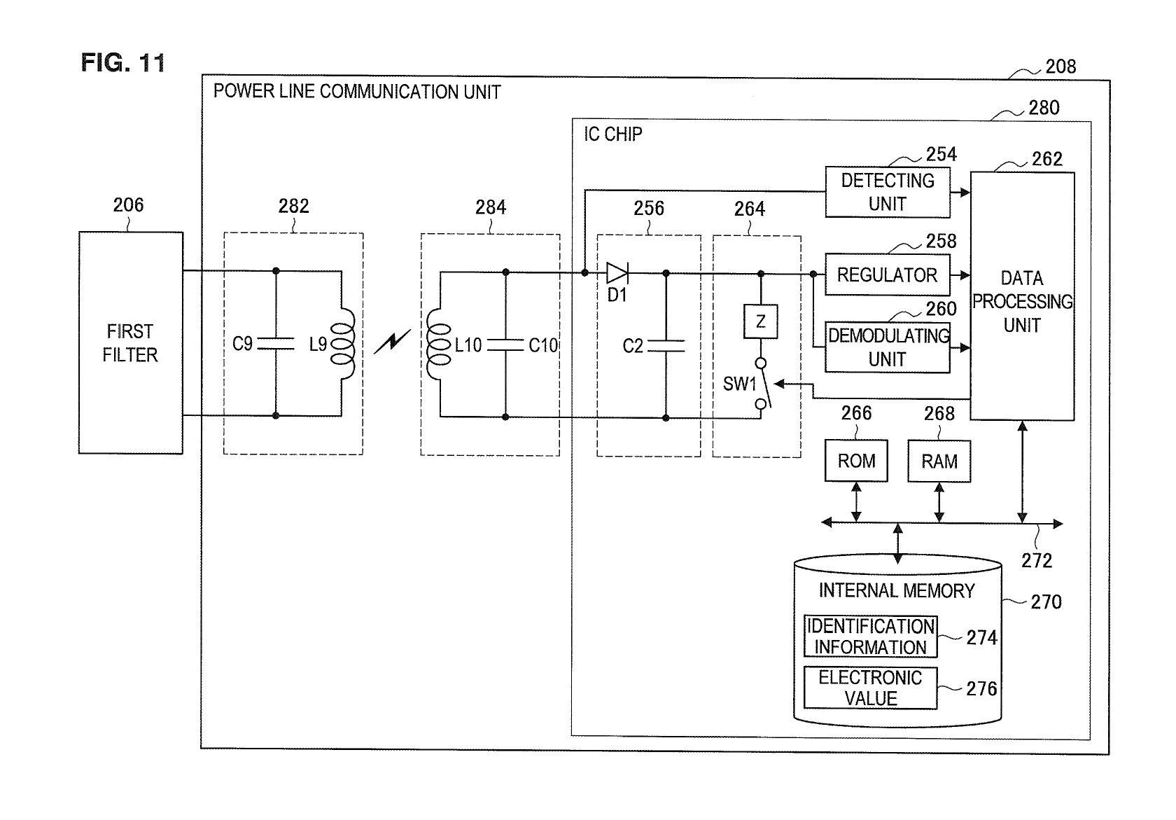

The configuration of the power line communication unit 208 according to the embodiment is not limited to the configuration illustrated in FIG. 10. FIG. 11 is a diagram illustrating another example of the configuration of the power line communication unit 208 included in the power receiving apparatus 200B according to the embodiment. In FIG. 11, the power line communication unit 208 is illustrated in conjunction with the first filter 206. The power line communication unit 208 according to the embodiment may not include the structural elements forming the IC chip 280 illustrated in FIG. 11 in a form of an IC chip.

The power line communication unit 208 according to another embodiment includes a first high-frequency wave transmitting/receiving unit 282, a second high-frequency wave transmitting/receiving unit 284, and an IC chip 280.

The first high-frequency wave transmitting/receiving unit 282 includes a coil L9 having predetermined inductance and a capacitor C9 having predetermined capacitance and forms a resonance circuit. In this case, a frequency of a high-frequency signal such as 13.56 [MHz] is exemplified as a resonance frequency of the first high-frequency wave transmitting/receiving unit 282. By the above configuration, the first high-frequency wave transmitting/receiving unit 282 can transmit the high-frequency signal transmitted from the first filter 206 and receive the response signal transmitted from the second high-frequency wave transmitting/receiving unit 284. That is, the first high-frequency wave transmitting/receiving unit 282 executes a function as a first communication antenna in the power line communication unit 208.

The second high-frequency wave transmitting/receiving unit 284 includes a coil L10 having predetermined inductance and a capacitor C10 having predetermined capacitance and forms a resonance circuit. In this case, a frequency of a high-frequency signal such as 13.56 [MHz] is exemplified as a resonance frequency of the second high-frequency wave transmitting/receiving unit 284. By the above configuration, the second high-frequency wave transmitting/receiving unit 284 can receive the high-frequency signal transmitted from the first high-frequency wave transmitting/receiving unit 282 and transmit the response signal. Specifically, the second high-frequency wave transmitting/receiving unit 284 generates an inductive voltage by electromagnetic induction according to reception of the high-frequency signal and outputs a reception voltage obtained by resonating the inductive voltage with a predetermined resonance frequency to the IC chip 280. The second high-frequency wave transmitting/receiving unit 284 performs transmission of the response signal by the load modulation performed in the load modulating unit 264 included in the IC chip 280. That is, the second high-frequency wave transmitting/receiving unit 284 executes a function as a second communication antenna in the power line communication unit 208.

The IC chip 280 executes the same processing as the IC chip 280 illustrated in FIG. 10, on the basis of the reception voltage transmitted from the second high-frequency wave transmitting/receiving unit 284.

Similar to the configuration illustrated in FIG. 10, by the configuration illustrated in FIG. 11, the power line communication unit 208 obtains power from the received high-frequency signal, is driven, and executes processing shown by the received high-frequency signal, and can transmit the response signal according to the processing by the load modulation. When the power line communication unit 208 has the configuration illustrated in FIG. 11, the IC chip relating to the NFC or the RFID can be diverted and mounting is facilitated.

Referring to FIG. 5 again, an example of a configuration relating to the power line communication according to the embodiment in the power receiving apparatus 200B according to the embodiment will be described. The second filter 210 executes a function of filtering a signal that may be transmitted from the side of the external apparatus such as the power supplying apparatus 100B through the power line PL. Specifically, the second filter 210 has a function of intercepting at least the high-frequency signal transmitted by the external apparatus or the high-frequency signal transmitted by the power line communication unit 208 and not intercepting a signal of a frequency of power supplied through the power line PL. The power receiving apparatus 200B includes the second filter 210 and can intercept the high-frequency signal relating to communication through the power line or a noise component transmitted from the side of the external apparatus. That is, the second filter 210 executes a function as a so-called power splitter, similar to the second filter 112 included in the power supplying apparatus 100B.

In this case, the second filter 210 can have the same configuration as the second filter 112 of the power supplying apparatus 100B illustrated in FIG. 9. The configuration of the second filter 210 according to the embodiment is not limited to the configuration illustrated in FIG. 9.

In the power supplying apparatus and the power receiving apparatus according to the embodiment, the power line communication unit 108 illustrated in FIG. 5 is included in the power supplying apparatus according to the embodiment and the power line communication unit 208 illustrated in FIG. 5 is included in the power receiving apparatus according to the embodiment. Thereby, the power line communication in which the wireless communication technology such as the communication technology based on the NFC is applied to the wired communication can be performed.

In this case, because a circuit scale of a communication device using the wireless communication technology such as the communication technology based on the NFC is significantly smaller than a circuit scale of an existing PLC modem, a size of the communication device can be decreased to a size of the IC chip. For example, apparatuses that can perform communication using the wireless communication technology such as the communication technology based on the NFC, such as a mobile phone on which an IC card or an IC chip is mounted, have spread. Therefore, the communication device using the wireless communication technology such as the communication technology based on the NFC or the RFID technology is cheaper than the existing PLC modem.

By applying the wireless communication technology such as the communication technology based on the NFC or the RFID technology to the wired communication, the power receiving apparatus according to the embodiment obtains power from the high-frequency signal received through the power line, is driven, and performs the load modulation, and can transmits the stored information. That is, in a communication system that includes the power supplying apparatus and the power receiving apparatus according to the embodiment, the power receiving apparatus can perform communication by wire, even though the power receiving apparatus does not include a separate power supply circuit to perform communication. The power receiving apparatus according to the embodiment can transmit the stored information by performing the load modulating, even though a signal according to a user operation (signal showing an instruction of the user) is not input to the power receiving apparatus.

Therefore, if the wireless communication technology such as the communication technology based on the NFC or the RFID technology is used, wired communication that enables reduction of a cost, alleviation of a limitation of the size of the communication device, and reduction of consumption power as compared with the case in which the wired communication according to the related art such as the existing PLC is used can be realized.

### (Power Supplying Apparatus According to Embodiment)

Next, an example of a configuration of the power supplying apparatus according to the embodiment that can execute the processing according to the state management method according to the embodiment will be described. Hereinafter, the example of the configuration of the power supplying apparatus according to the embodiment will be described on the basis of an example of the case in which the power supplying apparatus and the power receiving apparatus (external apparatus of the power supply object) perform communication by the power line communication according to the embodiment illustrated in FIG. 5.

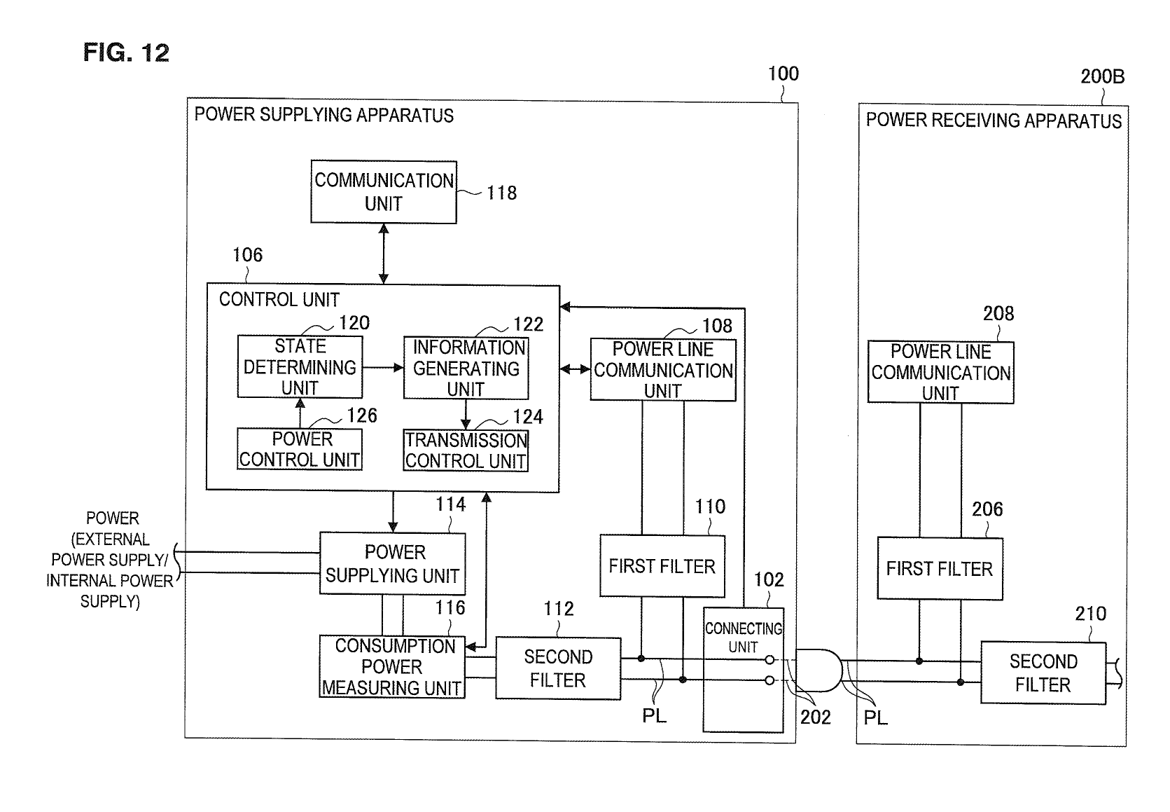

FIG. 12 is a diagram illustrating an example of a configuration of a power supplying apparatus 100 according to the embodiment. In FIG. 12, the power supplying apparatus 100 is illustrated in conjunction with the power receiving apparatus 200B illustrated in FIG. 5.

The power supplying apparatus 100 includes a connecting unit 102, a control unit 106, a power line communication unit 108, a first filter 110, a second filter 112, a power supplying unit 114, a consumption power measuring unit 116, and a communication unit 118.

The power supplying apparatus 100 may include a ROM, a RAM, a storage unit, a display unit, a timing device composed of an oscillator, and a detecting unit that are not illustrated in the drawings. The power supplying apparatus 100 connects the individual structural elements by a bus functioning as a transmission path of data.

The control unit 106 is configured using an MPU or various processing circuits and wholly controls the power supplying apparatus 100. The control unit 106 includes a state determining unit 120, an information generating unit 122, a transmission control unit 124, and a power control unit 126 and takes the initiative in executing the processing according to the state management method according to the embodiment.

The state determining unit 120 takes the initiative in executing the processing of (1) (determination processing) and determines whether the power supply with respect to the external apparatus of the power supply object is enabled. Specifically, the state determining unit 120 executes one or more processing among the determination processing according to the first example to the determination processing according to the fourth example. The state determining unit 120 transmits a signal (or data) showing a determination result to the information generating unit 122.

The information generating unit 122 takes the initiative in executing the processing of (2) (information generation processing) and generates evidence information when the power supply with respect to the external apparatus of the power supply object is disabled. Specifically, the information generating unit 122 generates the evidence information, when a signal transmitted from the state determining unit 120 shows that it is not determined that the power supply with respect to the external apparatus of the power supply object is enabled.

The transmission control unit 124 takes the initiative in executing the processing of (3) (state management processing) and transmits the evidence information generated in the information generating unit 122 to the external apparatus of the transmission object.

Specifically, when transmission destination information stored in the storage unit shows the power receiving apparatus 200B (external apparatus of the power supply object) corresponding to the external apparatus of the transmission object, the transmission control unit 124 causes the power line communication unit 108 to transmit the generated evidence information to the power receiving apparatus 200B. When the transmission destination information stored in the storage unit shows an apparatus other than the power receiving apparatus 200B (external apparatus of the power supply object) corresponding to the external apparatus of the transmission object, the transmission control unit 124 causes the communication unit 118 to transmit the generated evidence information to the external apparatus shown by the transmission destination information.

The power control unit 126 selectively transmits power to the external apparatus. Specifically, the power control unit 126 transmits a control signal to control selective power supply from the power supplying unit 114 to the power line PL to the power supplying unit 114, controls an operation of the power supplying unit 114, and selectively transmits power to the external apparatus.

When information showing that a battery has been fully charged, which has been received by the power line communication unit 108, is received, the power control unit 126 transmits a signal, which shows that the power supply with respect to the external apparatus of the power supply object has been completed, to the state determining unit 120.

The power control unit 126 may manage an amount of power supplied to the external apparatus by the power supplying unit 114 or value of power supplied on the basis of the power amount and a unit price of the power. In the case in which the amount of supplied power or the value of the supplied power is managed, the power control unit 126 can transmit a signal, which shows that the power supply with respect to the external apparatus of the power supply object has been completed, to the state determining unit 120, when it is determined that power of a predetermined amount or a predetermined amount of money has been supplied.

The power control unit 126 may transmit a control signal to control a start of a measurement of consumption power in the external apparatus such as the power receiving apparatus 200B in the consumption power measuring unit 116 or a stop of the measurement to the consumption power measuring unit 116 and control an operation of the consumption power measuring unit 116.

The control unit 106 includes a state determining unit 120, an information generating unit 122, a transmission control unit 124, and a power control unit 126 and takes the initiative in executing the processing according to the state management method according to the embodiment.

The configuration of the control unit that is included in the power supplying apparatus according to the embodiment is not limited to the configuration illustrated in FIG. 12. For example, the control unit that is included in the power supplying apparatus according to the embodiment may not include the power control unit 126. Even when the control unit included in the power supplying apparatus according to the embodiment does not include the power control unit 126, the control unit included in the power supplying apparatus according to the embodiment can execute the processing of (1) (determination processing) to the processing of (3) (transmission control processing) according to the state management method according to the embodiment.

When the control unit included in the power supplying apparatus according to the embodiment does not include the power control unit 126, the power supplying apparatus according to the embodiment may include the power control unit 126 separately or may not include the power control unit 126. Even when the power supplying apparatus according to the embodiment does not include the power control unit 126, the state determining unit 120 can execute processing, on the basis of the signal showing that the power supply with respect to the external apparatus of the power supply object has been completed, which is transmitted from the external apparatus having the same function as the power control unit 126.

The power supplying apparatus according to the embodiment can individually include at least one of the state determining unit 120, the information generating unit 122, the transmission control unit 124, and the power control unit 126 illustrated in FIG. 12 (for example, each unit is realized by an individual processing circuit).

The control unit that is included in the power supplying apparatus according to the embodiment may further include a charging processing unit that takes the initiative in executing the charging processing according to the embodiment and/or a recording control unit that executes the recording control processing according to the embodiment.

The power line communication unit 108 executes a function as a communication unit (a part of the communication unit) that performs communication with the external apparatus of the power supply object. For example, as described with reference to FIGS. 6 and 7, communication in the power line communication unit 108 is controlled by the control unit 106 and the power line communication unit 108 transmits a demodulated response signal to the control unit 106.

The power supplying unit 114 selectively connects a power supply (for example, an internal power supply or an external power supply) and a power line PL, on the basis of a control signal transmitted from the control unit 106 (in the strict sense, the power control unit 126), and selectively supplies power to the power line PL.

In this case, a switch that is turned on/off on the basis of a control signal transmitted from the control unit 106 is exemplified as the power supplying unit 114. The switch is configured using a p-channel-type MOSFET or an n-channel-type MOSFET. However, a configuration of the switch is not limited to the above example.

The consumption power measuring unit 116 measures consumption power (corresponding to power supplied to the external apparatus of the power supply object) that is consumed by the external apparatus of the power supply object such as the power receiving apparatus 200B connected to the connecting unit 102. The consumption power measuring unit 116 transmits information of the measured consumption power to the control unit 106. The consumption power measuring unit 116 can selectively measure the consumption power, on the basis of the control signal transmitted from the control unit 106 (in the strict sense, the power control unit 126). In this case, a consumption power measurer is exemplified as the consumption power measuring unit 116.

The communication unit 118 is a communication mechanism included in the power supplying apparatus 100 and performs wired/wireless communication with the external apparatus (for example, the external apparatus associated with the external apparatus of the power supply object or the external apparatus not associated with the external apparatus of the power supply object) other than the external apparatus of the power supply object or the external apparatus such as the external charging processing apparatus, through the network (or directly). The communication of the communication unit 118 is controlled by the control unit 106.

In this case, a communication antenna and a radio frequency (RF) circuit (wireless communication), an IEEE802.15.1 port and a transmission/reception circuit (wireless communication), an IEEE802.11b port and a transmission/reception circuit (wireless communication), or a local area network (LAN) terminal and a transmission/reception circuit (wired communication) are exemplified as the communication unit 118. The communication unit 118 may have a configuration corresponding to any standard that can perform communication, such as a universal serial bus (USB) terminal and a transmission/reception circuit, or any configuration that can perform communication with the external apparatus through the network. As the network according to the embodiment, a wired network such as a LAN or a wide area network (WAN), a wireless network such as a wireless local area network (WLAN) or a wireless wide area network (WWAN) through a base station, or the Internet using a communication protocol such as a transmission control protocol/Internet protocol (TCP/IP) is exemplified.

By the configuration illustrated in FIG. 12, the power supplying apparatus 100 executes the processing (for example, the processing of (1) (determination processing) to the processing of (3) (transmission control processing)) according to the state management method according to the embodiment. Therefore, by the configuration illustrated in FIG. 12, the power supplying apparatus 100 can securely leave information when the power supply is not performed.

The configuration of the power supplying apparatus according to the embodiment is not limited to the configuration illustrated in FIG. 12.

### [1] First Modification

For example, the power supplying apparatus according to the embodiment may have a configuration in which the communication unit 118 is not provided. Even when a power supplying apparatus according to a first modification of the embodiment has the configuration in which the communication unit 118 is not provided, the power supplying apparatus can execute the processing of (1) (determination processing) to the processing of (3) (transmission control processing). Therefore, the power supplying apparatus according to the first modification of the embodiment can achieve the same effect as the power supplying apparatus 100 illustrated in FIG. 12.

### [2] Second Modification

For example, in FIG. 12, the configuration in which the power supplying apparatus and the power receiving apparatus (an example of the external apparatus of the power supply object) according to the embodiment perform communication by the power line communication according to the embodiment is illustrated. However, the power supplying apparatus and the power receiving apparatus according to the embodiment can perform communication by the wireless communication according to the embodiment. Specifically, when communication is performed by the wireless communication according to the embodiment, the power supplying apparatus and the power receiving apparatus according to the embodiment have the configuration in which communication is performed by the wireless communication according to the embodiment illustrated in FIG. 3, instead of the configuration in which communication is performed by the power line communication according to the embodiment illustrated in FIG. 5.

Even when a power supplying apparatus according to a second modification of the embodiment has the configuration in which communication is performed by the wireless communication according to the embodiment, the power supplying apparatus can execute the processing of (1) (determination processing) to the processing of (3) (transmission control processing). Therefore, the power supplying apparatus according to the second modification of the embodiment can achieve the same effect as the power supplying apparatus 100 illustrated in FIG. 12.

### [3] Third Modification

The power supplying apparatus according to the embodiment may have both the configuration in which communication is performed by the power line communication according to the embodiment and the configuration in which communication is performed by the wireless communication according to the embodiment. Specifically, the power supplying apparatus according to the embodiment includes the configuration in which communication is performed by the wireless communication according to the embodiment illustrated in FIG. 3 and the configuration in which communication is performed by the power line communication according to the embodiment illustrated in FIG. 5.

Even when a power supplying apparatus according to a third modification of the embodiment has both the configuration in which communication is performed by the power line communication according to the embodiment and the configuration in which communication is performed by the wireless communication according to the embodiment, the power supplying apparatus can execute the processing of (1) (determination processing) to the processing of (3) (transmission control processing). Therefore, the power supplying apparatus according to the third modification of the embodiment can achieve the same effect as the power supplying apparatus 100 illustrated in FIG. 12.

### [4] Fourth Modification

When there is an apparatus (or a circuit) having a function corresponding to the power supplying unit 114 as an external apparatus (or a circuit) of the power supplying apparatus according to the embodiment, the power supplying apparatus according to the embodiment may not include the power supplying unit 114. When there is an apparatus (or a circuit) having a function corresponding to the consumption power measuring unit 116 as the external apparatus (or the circuit) of the power supplying apparatus according to the embodiment, the power supplying apparatus according to the embodiment may not include the consumption power measuring unit 116. Even when a power supplying apparatus according to a fourth modification of the embodiment does not include the power supplying unit 114 or the consumption power measuring unit 116 in the above case, the power supplying apparatus can execute the processing of (1) (determination processing) to the processing of (3) (transmission control processing). Therefore, the power supplying apparatus according to the fourth modification of the embodiment can achieve the same effect as the power supplying apparatus 100 illustrated in FIG. 12.

### [5] Fifth Modification

The power supplying apparatus according to the embodiment may not include one or more structural elements among the communication units to perform the power line communication according to the embodiment, such as the power line communication unit 108 and the first filter 110, the structural elements relating to the communication, such as the second filter 112, and the communication unit 118. Even when a power supplying apparatus according to a fifth modification of the embodiment does not include one or more structural elements among the communication units to perform the power line communication according to the embodiment, the power supplying apparatus can transmit evidence information to the external apparatus of the transmission object through the included structural elements relating to the communication and/or a connected external communication apparatus (not illustrated in the drawings). That is, even when the power supplying apparatus according to the fifth modification of the embodiment does not include one or more structural elements among the communication units to perform the power line communication according to the embodiment, the power supplying apparatus can execute the processing of (1) (determination processing) to the processing of (3) (transmission control processing). Therefore, the power supplying apparatus according to the fifth modification of the embodiment can achieve the same effect as the power supplying apparatus 100 illustrated in FIG. 12.

### [6] Sixth Modification

The power supplying apparatus according to the embodiment may not include the connecting unit 102, when power is transmitted by wireless. When power is transmitted by wireless, the power supplying apparatus according to the embodiment includes a power transmitting device relating to wireless power transmission, such as a power transmitting device relating to power transmission using electromagnetic induction, a power transmitting device relating to power transmission using an electric wave (microwave), a power transmitting device relating to power transmission using resonance of a magnetic field, or a power transmitting device relating to power transmission using resonance of an electric field.

### [7] Seventh Modification

The power supplying apparatus according to the embodiment can have any combination configuration, such as a combination configuration of the configuration according to the first modification and the configuration according to the second modification, a combination configuration of the configuration according to the first modification and the configuration according to the third modification, . . . .

### (Power Receiving Apparatus According to Embodiment)

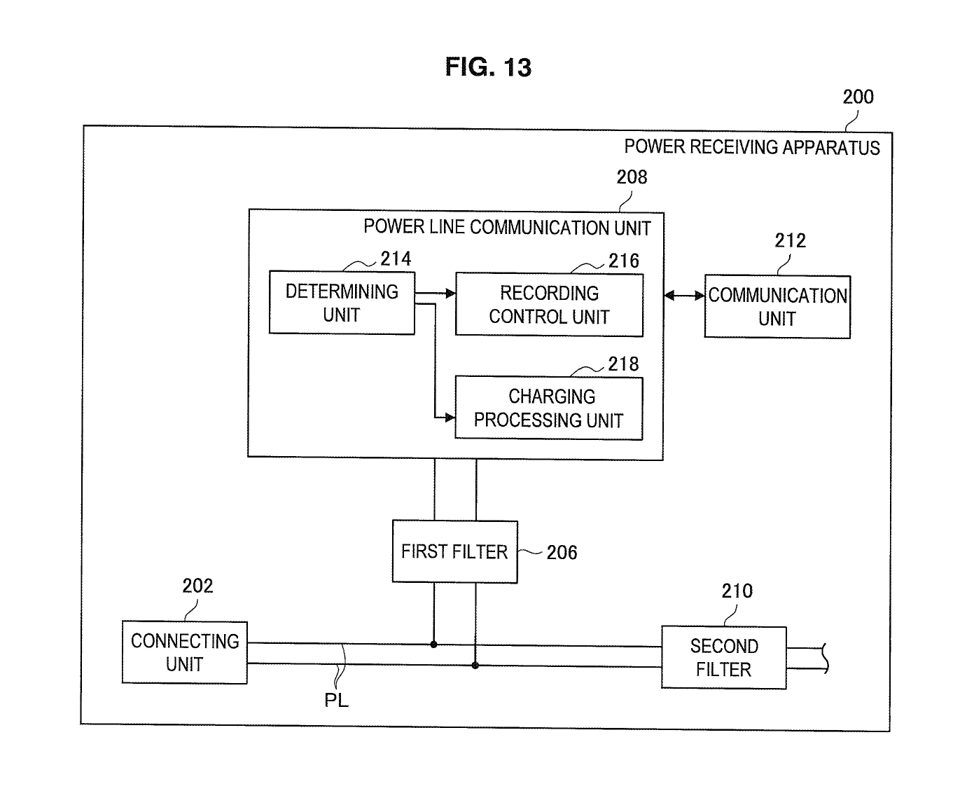

Next, an example of a configuration of the power receiving apparatus according to the embodiment that can execute the processing according to the state management method according to the embodiment will be described. Hereinafter, an example of the configuration of the power receiving apparatus according to the embodiment will be described on the basis of an example of the case in which the power receiving apparatus and the power supplying apparatus according to the embodiment perform communication by the power line communication according to the embodiment illustrated in FIG. 5. FIG. 13 is a diagram illustrating an example of the configuration of the power receiving apparatus 200 according to the embodiment.

The power receiving apparatus 200 includes a connecting unit 202, a first filter 206, a power line communication unit 208, a second filter 210, and a communication unit 212. The power receiving apparatus 200 may include a battery (not illustrated in the drawings), a storage unit (not illustrated in the drawings), and various devices (not illustrated in the drawings) to realize a function of the power receiving apparatus 200, at a rear step of the second filter 210 (the side opposite to the connecting unit 202 in the second filter 210 illustrated in FIG. 13). The communication unit 212 may be one of the structural elements to realize the function of the power receiving apparatus 200.

As described with reference to FIGS. 10 and 11, the power line communication unit 208 executes a function as a communication unit (a part of the communication unit) that performs the load modulation on the basis of the signal transmitted from the external apparatus such as the power supplying apparatus according to the embodiment and performs communication with the external apparatus.

The power line communication unit 208 includes a determining unit 214, a recording control unit 216, and a charging processing unit 218 and takes the initiative in executing the processing (for example, the processing of (I) (determination processing) to the processing of (III) (charging processing)) according to the state management method in the power receiving apparatus according to the embodiment. In this case, in the power line communication unit 208, the data processing unit 262 illustrated in FIGS. 10 and 11 functions as the determining unit 214, the recording control unit 216, and the charging processing unit 218.

FIG. 13 illustrates the example of the case in which the power line communication unit 208 includes the determining unit 214, the recording control unit 216, and the charging processing unit 218 and takes the initiative in executing the processing (for example, the processing of (I) (determination processing) to the processing of (III) (charging processing)) according to the state management method in the power receiving apparatus according to the embodiment. However, the configuration of the power receiving apparatus according to the embodiment is not limited to the above example. For example, the power receiving apparatus according to the embodiment may individually include one or more structural elements among the determining unit 214, the recording control unit 216, and the charging processing unit 218. That is, in the power receiving apparatus according to the embodiment, one or more structural elements among the determining unit 214, the recording control unit 216, and the charging processing unit 218 can be realized by an individual processing circuit such as an MPU. When one or more structural elements among the determining unit 214, the recording control unit 216, and the charging processing unit 218 are included separately from the power line communication unit 208, the structural elements that are included separately from the power line communication unit 208 executes the processing according to the state management method according to the embodiment, by power obtained on the basis of the high-frequency signal, power obtained from the power line PL, or power obtained from the internal power supply such as the battery.

The determining unit 214 takes the initiative in executing the processing of (I) (determination processing) and determines whether the evidence information according to the embodiment is received. The determining unit 214 may determine information that is included in the received evidence information. The determining unit 214 transmits a signal (or data) showing a determination result to the recording control unit 216 and the charging processing unit 218.

The recording control unit 216 takes the initiative in executing the processing of (II) (recording control processing) and stores the received evidence information in the recording medium, when it is determined by the determining unit 214 that the evidence information is received. In this case, the internal memory 270 illustrated in FIG. 10 or 11, a storage unit (not illustrated in the drawings), a connected removable external recording medium, or a recording medium of an external apparatus connected by wire or wireless through the communication unit 212 is exemplified as the recording medium to store the evidence information by the recording control unit 216. When the evidence information is stored in the recording medium of the external apparatus, the recording control unit 216 transmits the evidence information and a recording processing command to record the evidence information in the external apparatus to the communication unit 212.

The charging processing unit 218 takes the initiative in executing the processing (charging processing) of (III). When it is determined by the determining unit 214 that the information regarding the value for the supplied power is included in the received evidence information, the charging processing unit 218 executes the charging processing, on the basis of the information regarding the value for the supplied power to be included in the evidence information.

The communication unit 212 is a communication mechanism included in the power receiving apparatus 200 and performs wired/wireless communication with the external charging processing apparatus or the external apparatus such as the server, through the network (or directly). For example, when the charging processing unit 218 executes the indirect charging processing, the charging processing unit 218 causes the communication unit 212 to transmit the information regarding the value for the supplied power to be included the evidence information to the external charging processing apparatus. The charging processing unit 218 may transmit identification information showing the power receiving apparatus 200 (corresponding to the charging object apparatus) to the communication unit 212.

The communication unit 212 is driven by the power obtained on the basis of the high-frequency signal, the power obtained from the power line PL, or the power obtained from the internal power supply such as the battery and performs communication.

In this case, a communication antenna and an RF circuit (wireless communication), an IEEE802.15.1 port and a transmission/reception circuit (wireless communication), an IEEE802.11b port and a transmission/reception circuit (wireless communication), or a LAN terminal and a transmission/reception circuit (wired communication) are exemplified as the communication unit 212. The communication unit 212 may have a configuration corresponding to any standard that can perform communication, such as a USB terminal and a transmission/reception circuit, or any configuration that can perform communication with the external apparatus through the network.

By the configuration illustrated in FIG. 13, the power receiving apparatus 200 executes the processing (for example, the processing of (I) (determination processing) to the processing of (III) (charging processing)) according to the state management method in the power receiving apparatus according to the embodiment. Therefore, by the configuration illustrated in FIG. 13, the power receiving apparatus 200 can securely leave information when the power supply is not performed. By the configuration illustrated in FIG. 13, the power receiving apparatus 200 can selectively execute the charging processing based on the received evidence information.

The configuration of the power receiving apparatus according to the embodiment is not limited to the configuration illustrated in FIG. 13.

### [1] First Modification

For example, the power receiving apparatus according to the embodiment may have a configuration in which the communication unit 212 is not provided. Even when the power receiving apparatus according to the embodiment does not include the communication unit 212, the power receiving apparatus executes the charging processing using the electronic value stored in the internal memory 270 illustrated in FIGS. 10 and 11 and can execute the processing of (I) (determination processing) to the processing of (III) (charging processing). Therefore, a power receiving apparatus according to a first modification of the embodiment can achieve the same effect as the power receiving apparatus 200 illustrated in FIG. 13.

### [2] Second Modification

For example, in FIG. 13, the configuration in which the power receiving apparatus according to the embodiment performs communication by the power line communication according to the embodiment is illustrated. However, the power receiving apparatus according to the embodiment can perform communication by the wireless communication according to the embodiment. Specifically, when the communication is performed by the wireless communication according to the embodiment, the power receiving apparatus according to the embodiment has the configuration in which the communication is performed by the wireless communication according to the embodiment illustrated in FIG. 3, instead of the configuration in which the communication is performed by the power line communication according to the embodiment illustrated in FIG. 5.

Even when a power receiving apparatus according to a second modification of the embodiment has a configuration in which the communication is performed by the wireless communication according to the embodiment, the power receiving apparatus can execute the processing of (I) (determination processing) to the processing of (III) (charging processing). Therefore, the power receiving apparatus according to the second modification of the embodiment can achieve the same effect as the power receiving apparatus 200 illustrated in FIG. 13.

### [3] Third Modification

The power receiving apparatus according to the embodiment may have both the configuration in which communication is performed by the power line communication according to the embodiment and the configuration in which communication is performed by the wireless communication according to the embodiment. Specifically, the power receiving apparatus according to the embodiment includes the configuration in which communication is performed by the wireless communication according to the embodiment illustrated in FIG. 3 and the configuration in which communication is performed by the power line communication according to the embodiment illustrated in FIG. 5.

Even when a power receiving apparatus according to a third modification of the embodiment has both the configuration in which communication is performed by the power line communication according to the embodiment and the configuration in which communication is performed by the wireless communication according to the embodiment, the power receiving apparatus can execute the processing of (I) (determination processing) to the processing of (III) (charging processing). Therefore, the power receiving apparatus according to the third modification of the embodiment can achieve the same effect as the power receiving apparatus 200 illustrated in FIG. 13.

### [4] Fourth Modification

When the power receiving apparatus according to the embodiment may have the configuration in which the charging processing unit 218 is not provided. Even when the power receiving apparatus according to the embodiment has the configuration in which the charging processing unit 218 is not provided, the power receiving apparatus can execute the processing of (I) (determination processing) and the processing of (II) (recording control processing). Therefore, a power receiving apparatus according to a fourth modification of the embodiment can securely leave information when the power supply is not performed.

### [5] Fifth Modification

The power receiving apparatus according to the embodiment may not include the connecting unit 202, when power is transmitted by wireless. When the power is transmitted by wireless, the power receiving apparatus according to the embodiment includes a power receiving device relating to wireless power transmission, such as a power receiving device relating to power transmission using electromagnetic induction, a power receiving device relating to power transmission using an electric wave (microwave), a power receiving device relating to power transmission using resonance of a magnetic field, or a power receiving device relating to power transmission using resonance of an electric field.

### [6] Sixth Modification

The power receiving apparatus according to the embodiment may further include a notification control unit (not illustrated in the drawings) that notifies a user of the light receiving apparatus according to the embodiment of content of the received evidence information. The notification control unit notifies the user of the power receiving apparatus according to the embodiment of the content of the received evidence information, using a visual notification method using a character, an image, or flickering of light or an auditory notification method using a sound (including music or a beep sound; this is applicable to the following description). In this case, a display unit (not illustrated in the drawings) included in the power receiving apparatus according to the embodiment, a sound output device such as an amplifier or a speaker included in the power receiving apparatus according to the embodiment, or an external apparatus such as an external display device or an external sound output device is exemplified as a notification performance object by the notification control unit.

### [7] Seventh Modification

The power receiving apparatus according to the embodiment can have any combination configuration, such as a combination configuration of the configuration according to the first modification and the configuration according to the second modification, a combination configuration of the configuration according to the first modification and the configuration according to the third modification, . . . .

### [8] Other Modification

The power receiving apparatus according to the embodiment may have a so-called reader/writer function, similar to the power supplying apparatus according to the embodiment.

The power supplying apparatus has been exemplified as the embodiment. However, the embodiment is not limited to the above form. The embodiment can be applied to various apparatuses or facilities, such as an outlet provided in a building, a computer such as a PC or a server, a power supply tab, an apparatus providing power to an electric vehicle or an apparatus working with power, and a display device. The embodiment can be applied to a vehicle such as an electric vehicle or a moving object that executes a function as the power supplying apparatus. The power supplying apparatus according to the embodiment may receive power that is transmitted from the external apparatus. That is, the power supplying apparatus according to the embodiment may execute a function as the power receiving apparatus.

The power receiving apparatus has been exemplified as the embodiment. However, the embodiment is not limited to the above form. The embodiment can be applied to various apparatuses working with power, such as a computer such as a PC, a communication apparatus such as a mobile phone or a smart phone, a video/music reproducing apparatus (or a video/music recording/reproducing apparatus), a portable game machine, a display device, a television receiver, an illumination apparatus, a toaster, and a vehicle such an electric vehicle driven with power. The embodiment can be applied to a plug. The power receiving apparatus according to the embodiment may transmit power to the external apparatus. That is, the power receiving apparatus according to the embodiment may execute a function as the power supplying apparatus.

### (Program According to Embodiment)

### [1] Program Relating to Power Supplying Apparatus According to Embodiment

A program for causing a computer to function as the power supplying apparatus according to the embodiment (for example, a program that can execute the processing according to the state management method according to the embodiment in the power supplying apparatus according to the embodiment, such as the processing of (1) (determination processing) to the processing of (3) (transmission control processing) or the processing of (1) (determination processing) to the processing of (3) (transmission control processing) and the recording control processing) is executed in the computer, thereby securely leaving information when the power supply is not performed.

### [2] Program Relating to Power Receiving Apparatus According to Embodiment

A program for causing a computer to function as the power receiving apparatus according to the embodiment (for example, a program that can execute the processing according to the state management method according to the embodiment in the power receiving apparatus according to the embodiment, such as the processing of (I) (determination processing) and the processing of (II) (recording control processing) or the processing of (I) (determination processing) to the processing of (III) (charging processing)) is executed in the computer, thereby securely leaving information when the power supply is not performed.

It should be understood by those skilled in the art that various modifications, combinations, sub-combinations and alterations may occur depending on design requirements and other factors insofar as they are in the scope of the appended claims or the equivalents thereof.

For example, in the above description, the program (computer program) for causing the computer to function as the power supplying apparatus according to the embodiment or the power receiving apparatus according to the embodiment is provided. However, the embodiment can provide the recording media in which the programs are individually stored or the recording media in which all of the programs are stored together.

The configuration described above is only an example of the embodiment and is included in a technical range of the present disclosure.

Additionally, the present technology may also be configured as below.

(1) A power supplying apparatus including:

a state determining unit that determines whether power supply with respect to an external apparatus of a power supply object to supply power is enabled;

an information generating unit that generates evidence information regarding a power supply disabled state, when the power supply with respect to the external apparatus of the power supply object is disabled; and

a transmission control unit that transmits the generated evidence information to at least one external apparatus of a transmission object.

(2) The power supplying apparatus according to (1),

wherein the information generating unit generates the evidence information that includes information regarding a power supply time.

(3) The power supplying apparatus according to (1) or (2),

wherein the information generating unit generates the evidence information that includes information regarding a value for supplied power.

(4) The power supplying apparatus according to any one of (1) to (3),

wherein the state determining unit authenticates the external apparatus of the power supply object based on identification information acquired from the external apparatus of the power supply object, and

the state determining unit determines whether the power supply with respect to the external apparatus of the power supply object is enabled based on an authentication result.

(5) The power supplying apparatus according to (4), further including:

a communication unit that communicates with the external apparatus of the power supply object,

wherein the state determining unit authenticates the external apparatus of the power supply object based on the identification information obtained by communication of the communication unit with the external apparatus of the power supply object.

(6) The power supplying apparatus according to (5),

wherein the communication unit acquires the identification information that is transmitted when load modulation is performed in the external apparatus of the power supply object.

(7) The power supplying apparatus according to (6),

wherein the communication unit includes

a power line communication unit that transmits a high-frequency signal of a frequency higher than a frequency of the power by a power line through which power is transmitted and communicates with the external apparatus of the power supply object; and

a communication filter that is connected between the power line communication unit and the power line and intercepts at least a signal of the frequency of the power and does not intercept the high-frequency signal.

(8) The power supplying apparatus according to (6),

wherein the communication unit includes

a communication antenna that transmits a carrier according to a high-frequency signal having a frequency higher than a frequency of the power; and

a wireless communication unit that transmits the high-frequency signal through the communication antenna and communicates with the external apparatus of the power supply object.

(9) The power supplying apparatus according to any one of (1) to (3), further including:

a connecting unit that connects a power line, through which power is transmitted, to the external apparatus,

wherein the state determining unit determines whether the power supply with respect to the external apparatus of the power supply object is enabled, based on a connection state of the external apparatus to the connecting unit.

(10) The power supplying apparatus according to any one of (1) to (3), further including:

a detecting unit that detects an external apparatus of a power supply object,

wherein the state determining unit determines whether the power supply with respect to the external apparatus of the power supply object is enabled based on a detection result of the external apparatus by the detecting unit.

(11) The power supplying apparatus according to any one of (1) to (10),

wherein the at least one external apparatus of the transmission object includes one or more external apparatuses selected from the external apparatus of the power supply object, an external apparatus associated with the external apparatus of the power supply object among external apparatuses other than the external apparatus of the power supply object, and an external apparatus not associated with the external apparatus of the power supply object among the external apparatuses other than the external apparatus of the power supply object.

(12) A power receiving apparatus including:

a determining unit that determines whether evidence information regarding a state in which power supply in a power supplying apparatus supplying power is disabled is received; and

a recording control unit that records the evidence information, when it is determined that the evidence information is received.

(13) The power receiving apparatus according to (12), further including:

a charging processing unit that selectively executes charging processing based on the evidence information, when it is determined that the evidence information is received,

wherein the determining unit determines information that is included in the received evidence information, and

the charging processing unit executes the charging processing, when information regarding a value for supplied power is included in the received evidence information.

(14) A state management method including:

determining whether power supply with respect to an external apparatus of a power supply object to supply power is enabled;

generating evidence information regarding a power supply disabled state, when the power supply with respect to the external apparatus of the power supply object is disabled; and

transmitting the generated evidence information to at least one external apparatus of a transmission object.

(15) A program for causing a computer to execute:

determining whether power supply with respect to an external apparatus of a power supply object to supply power is enabled;

generating evidence information regarding a power supply disabled state, when the power supply with respect to the external apparatus of the power supply object is disabled; and

transmitting the generated evidence information to at least one external apparatus of a transmission object.

The present disclosure contains subject matter related to that disclosed in Japanese Priority Patent Application JP 2012-085361 filed in the Japan Patent Office on Apr. 4, 2012, the entire content of which is hereby incorporated by reference.

What is claimed is:

1. A power supplying apparatus comprising:
a state determining unit that determines whether power supply with respect to an external apparatus of a power supply object to supply power is enabled;
an information generating unit that generates evidence information regarding a power supply disabled state, when the power supply with respect to the external apparatus of the power supply object is disabled; and
a transmission control unit that transmits the generated evidence information to at least one external apparatus of a transmission object.

2. The power supplying apparatus according to claim 1,
wherein the information generating unit generates the evidence information that includes information regarding a power supply time.

3. The power supplying apparatus according to claim 1,
wherein the information generating unit generates the evidence information that includes information regarding a value for supplied power.

4. The power supplying apparatus according to claim 1,
wherein the state determining unit authenticates the external apparatus of the power supply object based on identification information acquired from the external apparatus of the power supply object, and
the state determining unit determines whether the power supply with respect to the external apparatus of the power supply object is enabled based on an authentication result.

5. The power supplying apparatus according to claim 4, further comprising:
a communication unit that communicates with the external apparatus of the power supply object,
wherein the state determining unit authenticates the external apparatus of the power supply object based on the identification information obtained by communication of the communication unit with the external apparatus of the power supply object.

6. The power supplying apparatus according to claim 5,
wherein the communication unit acquires the identification information that is transmitted when load modulation is performed in the external apparatus of the power supply object.

7. The power supplying apparatus according to claim 6,
wherein the communication unit includes
a power line communication unit that transmits a high-frequency signal of a frequency higher than a frequency of the power by a power line through which power is transmitted and communicates with the external apparatus of the power supply object; and
a communication filter that is connected between the power line communication unit and the power line and intercepts at least a signal of the frequency of the power and does not intercept the high-frequency signal.

8. The power supplying apparatus according to claim 6,
wherein the communication unit includes
a communication antenna that transmits a carrier according to a high-frequency signal having a frequency higher than a frequency of the power; and
a wireless communication unit that transmits the high-frequency signal through the communication antenna and communicates with the external apparatus of the power supply object.

9. The power supplying apparatus according to claim 1, further comprising:
a connecting unit that connects a power line, through which power is transmitted, to the external apparatus,
wherein the state determining unit determines whether the power supply with respect to the external apparatus of the power supply object is enabled, based on a connection state of the external apparatus to the connecting unit.

10. The power supplying apparatus according to claim 1, further comprising:
a detecting unit that detects an external apparatus of a power supply object,
wherein the state determining unit determines whether the power supply with respect to the external apparatus of the power supply object is enabled based on a detection result of the external apparatus by the detecting unit.

11. The power supplying apparatus according to claim 1,
wherein the at least one external apparatus of the transmission object includes one or more external apparatuses selected from the external apparatus of the power supply object, an external apparatus associated with the external apparatus of the power supply object among external apparatuses other than the external apparatus of the power supply object, and an external apparatus not associated with the external apparatus of the power supply object among the external apparatuses other than the external apparatus of the power supply object.

12. A power receiving apparatus comprising:
a determining unit that determines whether evidence information regarding a state in which power supply in a power supplying apparatus supplying power is disabled is received; and
a recording control unit that records the evidence information, when it is determined that the evidence information is received.

13. The power receiving apparatus according to claim 12, further comprising:
a charging processing unit that selectively executes charging processing based on the evidence information, when it is determined that the evidence information is received,
wherein the determining unit determines information that is included in the received evidence information, and
the charging processing unit executes the charging processing, when information regarding a value for supplied power is included in the received evidence information.

14. A state management method comprising:
determining whether power supply with respect to an external apparatus of a power supply object to supply power is enabled;
generating evidence information regarding a power supply disabled state, when the power supply with respect to the external apparatus of the power supply object is disabled; and
transmitting the generated evidence information to at least one external apparatus of a transmission object.

15. A program for causing a computer to execute:
determining whether power supply with respect to an external apparatus of a power supply object to supply power is enabled;
generating evidence information regarding a power supply disabled state, when the power supply with respect to the external apparatus of the power supply object is disabled; and
transmitting the generated evidence information to at least one external apparatus of a transmission object.
